(19) United States
(12) Patent Application Publication
(10) Pub. No.: US 2017/0214963 A1
(43) Pub. Date: Jul. 27, 2017

(54) METHODS AND SYSTEMS RELATING TO METATAGS AND AUDIOVISUAL CONTENT

(71) Applicant: SKIPZA INC., Ottawa (CA)

(72) Inventors: FABRIZIO ROMANO DI FRANCO, OTTAWA (CA); ERIC GUY LAURIN, OTTAWA (CA); MICHELE ROMANO DI FRANCO, OTTAWA (CA)

(21) Appl. No.: 15/415,177

(22) Filed: Jan. 25, 2017

Related U.S. Application Data
(60) Provisional application No. 62/287,111, filed on Jan. 26, 2016.

(51) Int. Cl. H04N 21/431; G11B 27/031; H04N 21/262; H04N 21/4227; H04N 21/81; H04N 21/61; H04N 21/84; G11B 27/34

(52) U.S. Cl. CPC H04N 21/4312; H04N 21/84; G11B 27/031; G11B 27/34; H04N 21/4227; H04N 21/8166; H04N 21/6125; H04N 21/26258

(57) ABSTRACT

Today users are accustomed to “judging” items of media content from short abstract samples offered by service providers, media retailers/distributors, etc. and purchasing discrete portions, e.g. a track, rather than the entire work, e.g. an album, for example. Users are influenced by short content segments and use media players that support jumping between media content items whilst rendering an item. It would be beneficial to provide users with a means to associate tags for content portions they like etc. and subsequently play only these portions or the full item of content as well as filter content based upon other user's tags or tags acquired from family, friends, social media, crowdsourcing etc.

### CROSS-REFERENCE TO RELATED APPLICATIONS

This patent application claims the benefit of U.S. Patent Application 62/287,111 filed Jan. 26, 2016 entitled “Methods and Systems Relating to Metatags and Audiovisual Content.”

### FIELD OF THE INVENTION

This invention relates to audiovisual content and more particularly to methods exploiting metadata tagged audiovisual content from a user and/or other users including social networks.

### BACKGROUND OF THE INVENTION

The cost reductions, footprint reductions, etc. offered by semiconductor manufacturing techniques in microprocessors, organic light emitting diodes (OLEDs), wireless transceivers, and charge coupled devices (CCDs) have led to today's ubiquitous consumer electronics. Over the same period wireless and wired telecommunications networks have established ubiquitous connectivity of these consumer electronic devices, including, but not limited to, smartphones, laptops, tablets, smartwatches, fitness trackers, navigation systems, gaming systems, and entertainment systems to a wide range of services and enterprises hosted on remote servers. This network and servers commonly referred to as the Internet.

By 2020 the number of smartphones is expected to exceed 6 billion, used by approximately 70% of the global population, with wireless interfaces, Internet access, and data services with high definition displays, integral camera(s), global positioning system (GPS), multiple sensors (accelerometer, temperature, and humidity for example), as well as wired and wireless audio interfaces. However, these will still represent only approximately 25% of the total number of wirelessly connected devices in use by the global population wherein a significant portion of these will provide users with the ability to store and retrieve or stream audio, video, audiovisual and multimedia content.

Many electronic devices now allow users to bring with them many hours of high definition (HD) video or many tens of hours of audio and even almost infinitely more through streaming, the evolutions in digital media retailing/distribution and streaming have enabled consumers to become increasingly selective or transient in the audiovisual content that they listen to or view. Whereas a user previously could only purchase an entire audio album released by an artist or a boxed set of a television series for example, today they can purchase only a single track or a single episode. Accordingly, digital media retailing/distribution are increasingly focused towards ensuring delivery of a small number of popular tracks/episodes. Whilst historically popular audiovisual content was listed in a weekly released list of top selling singles, albums, videos, etc. based upon actual completed retail sales today a series, track, video, album etc. may become popular and “trend” as the result of “likes” within social media and thereby yield large numbers of revenue generating and non-revenue generating views, plays, etc.

Today users are already accustomed to “judging” items of media content from a short abstract offered by a service provider, e.g. Apple™ iTunes and other media retailers/distributors, and purchasing discrete tracks rather than an album, for example. This is without considering how many items of multimedia content include distinctive repetitive refrains of a few seconds wherein these may be subsequently sampled and purchased by users as ringtones or alerts upon their electronic devices such that users are increasingly influenced by short segments of content. Additionally, users are accustomed through service providers and applications such as YouTube™ and Apple™ iTunes respectively to jumping between items of media content without completing the currently playing item of content by a simple double click on a displayed icon or identifier of another item of media content.

Accordingly, it would be beneficial to provide user with a means to associate additional context to the media content they stream and acquire themselves or distribute to one or more other users, wherein the media content may be audio content, image content, video content, audiovisual content, and multimedia content irrespective of format, duration, content etc.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations in the prior art relating to user acquired content and more particularly to associating a contextual filter to the user acquired content when distributed.

In accordance with an embodiment of the invention there is provided a method of rendering an item of audiovisual content to a user comprising:

retrieving the item of audiovisual content;
retrieving an overlay relating to the item of audiovisual content comprising at least one tuple of a plurality of tuples, each tuple comprising data relating to timing information; and
rendering the item of audiovisual content in dependence upon the at least one tuple of the plurality of tuples.

In accordance with an embodiment of the invention there is provided a method of rendering an item of audiovisual content to a user comprising:
generating an overlay relating to the item of audiovisual content comprising at least one tuple of a plurality of tuples, each tuple comprising data relating to timing information; and
storing the overlay for subsequent retrieval in order to render the item of audiovisual content in dependence upon the at least one tuple of the plurality of tuples.

In accordance with an embodiment of the invention there is provided a data file comprising an identifier of an item of audiovisual content and at least one tuple of a plurality of tuples, each tuple comprising data relating to timing information for rendering the item of audiovisual content.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1A depicts examples of music players for fixed and portable electronic devices within the prior art;

FIG. 1B depicts examples of music players within the prior art;

FIG. 1C depicts examples of music editors within the prior art;

FIG. 1D depicts examples of music editors within the prior art;

FIG. 2 depicts a network environment within which embodiments of the invention may be employed;

FIG. 3 depicts a wireless portable electronic device supporting communications to a network such as depicted in FIG. 2 and as supporting embodiments of the invention;

FIG. 4 depicts simulated screenshots of an application in execution upon a portable electronic device according to an embodiment of the invention for a user tagging an item of audiovisual content;

FIG. 5 depicts simulated screenshots of an application in execution upon a portable electronic device according to an embodiment of the invention for a user tagging an item of audiovisual content;

FIG. 6 depicts simulated screenshots of an application in execution upon a portable electronic device according to an embodiment of the invention for a user playing audiovisual content based upon metadata tags provided by individuals or social networks;

FIG. 7 depicts simulated screenshots of an application in execution upon a portable electronic device according to an embodiment of the invention for a user viewing a collection of audiovisual content and metadata tagged elements selected by a social network;

FIG. 8 depicts simulated screenshots of an application in execution upon a portable electronic device according to an embodiment of the invention for a user viewing audiovisual elements and their collated metadata tags;

FIG. 9 depicts simulated screenshots of an application in execution upon a portable electronic device according to an embodiment of the invention for a user viewing an audiovisual element with its collated metadata tags and playing portions of the audiovisual element exceeding a threshold;

FIG. 10 depicts simulated screenshots of an application in execution upon a portable electronic device according to an embodiment of the invention for a user viewing multiple metadata tag filters associated with the audiovisual element and a playlist based upon a sequence of metadata tagged audiovisual elements;

FIG. 11 depicts simulated screenshots of an application in execution upon a portable electronic device according to an embodiment of the invention for a user exploiting metadata tag filter based overlays in conjunction with a multi-track AV media player for generating AV content;

FIG. 12 depicts simulated screenshots of an application in execution upon a portable electronic device according to an embodiment of the invention for a user exploiting metadata tag filter based overlays wherein tracks with and without overlays are being played;

FIG. 13 depicts simulated screenshots of an application in execution upon a portable electronic device according to an embodiment of the invention for a user exploiting metadata tag filter based overlays when adding metadata tags to an item of content being played;

FIG. 14 depicts simulated screenshots of an application in execution upon a portable electronic device according to an embodiment of the invention for a user exploiting metadata tag filter based overlays wherein the user is shown only a single overlay or multiple overlays.

### DETAILED DESCRIPTION

The present invention relates to user acquired content and more particularly to associating a contextual filter to the user acquired content when distributed

The ensuing description provides exemplary embodiment(s) only, and is not intended to limit the scope, applicability or configuration of the disclosure. Rather, the ensuing description of the exemplary embodiment(s) will provide those skilled in the art with an enabling description for implementing an exemplary embodiment. It being understood that various changes may be made in the function and arrangement of elements without departing from the spirit and scope as set forth in the appended claims.

A “portable electronic device” (PED) as used herein and throughout this disclosure, refers to a wireless device used for communications and other applications that requires a battery or other independent form of energy for power. This includes devices, but is not limited to, such as a cellular telephone, smartphone, personal digital assistant (PDA), portable computer, pager, portable multimedia player, portable gaming console, laptop computer, tablet computer, and an electronic reader.

A “fixed electronic device” (FED) as used herein and throughout this disclosure, refers to a wireless and/or wired device used for communications and other applications that requires connection to a fixed interface to obtain power. This includes, but is not limited to, a laptop computer, a personal computer, a computer server, a kiosk, a gaming console, a digital set-top box, an analog set-top box, an Internet enabled appliance, an Internet enabled television, and a multimedia player.

An “application” (commonly referred to as an “app”) as used herein may refer to, but is not limited to, a “software application” and an element of a “software suite” as used herein may refer to, but is not limited to, a computer program designed to allow an individual to perform an activity. An application thus differs from an operating system (which runs a computer), a utility (which performs maintenance or general-purpose chores), and a programming tools (with which computer programs are created). Generally, within the following description with respect to embodiments of the invention an application is generally presented in respect of software permanently and/or temporarily installed upon a PED and/or FED for the purposes of presenting a micro-survey to a consumer and/or customer.

A “social network” or “social networking service” as used herein may refer to, but is not limited to, a platform to build social networks or social relations among people who may, for example, share interests, activities, backgrounds, or real-life connections. This includes, but is not limited to, social networks such as U.S. based services such as Facebook™, Google+™ Tumblr™, YouTube™ and Twitter™; as well as Nexopia, Badoo, Bebo, VKontakte, Delphi, Hi5, Hyves, iWiW, Nasza-Klasa, Soup, Glocals, Skyrock, The Sphere, StudiVZ, Tagged, Tuenti, XING, Orkut, Mxit, Cyworld, Mixi, renren, weibo and Wretch.

“Social media” or “social media services” as used herein may refer to, but is not limited to, a means of interaction among people in which they create, share, and/or exchange information and ideas in virtual communities and networks. This includes, but is not limited to, social media services relating to magazines, Internet forums, weblogs, social blogs, microblogging, wikis, social networks, podcasts, photographs or pictures, tweets, video, rating and social bookmarking as well as those exploiting blogging, picture-sharing, video logs, wall-posting, music-sharing, crowdsourcing and voice over IP, to name a few. Social media services may be classified, for example, as collaborative projects (for example, Wikipedia); blogs and microblogs (for example, Twitter™); content communities (for example, YouTube and DailyMotion); social networking sites (for example, Facebook™); virtual game-worlds (e.g., World of Warcraft™); and virtual social worlds (e.g. Second Life™).

An “enterprise” as used herein may refer to, but is not limited to, a provider of a service and/or a product to a user, customer, or consumer. This includes, but is not limited to, a retail outlet, a store, a market, an online marketplace, a manufacturer, an online retailer, a charity, a utility, and a service provider. Such enterprises may be directly owned and controlled by a company or may be owned and operated by a franchisee under the direction and management of a franchiser.

A “service provider” as used herein may refer to, but is not limited to, a third party provider of a service and/or a product to an enterprise. This includes, but is not limited to, a retail outlet, a store, a market, an online marketplace, a manufacturer, an online retailer, a utility, an own brand provider, and a service provider wherein the service and/or product is at least one of marketed, sold, offered, and distributed by the enterprise solely or in addition to the service provider.

A ‘third party’ or “third party provider” as used herein may refer to, but is not limited to, a so-called “arms length” provider of a service and/or a product to an enterprise and/or service provider wherein the consumer and/or customer engages the third party but the actual service and/or product that they are interested in and/or purchase.

A “user” as used herein may refer to, but is not limited to, an enterprise, a service provider, and an individual accessing at least one of publishing software and/or publishing software according to embodiments of the invention from the viewpoint of publishing information.

“User information” as used herein may refer to, but is not limited to, user behavior information and/or user profile information. It may also include a user's biometric information, an estimation of the user's biometric information, or a projection/prediction of a user's biometric information derived from current and/or historical biometric information.

A “wearable device” or “wearable sensor” as used herein may refer to, but is not limited to, miniature electronic devices that are worn by the user including those under, within, with or on top of clothing and are part of a broader general class of wearable technology which includes “wearable computers” which in contrast are directed to general or special purpose information technologies and media development. Such wearable devices and/or wearable sensors may include, but not be limited to, smartphones, smart watches, e-textiles, smart shirts, activity trackers, smart glasses, environmental sensors, medical sensors, biological sensors, physiological sensors, chemical sensors, ambient environment sensors, position sensors, neurological sensors, drug delivery systems, medical testing and diagnosis devices, and motion sensors.

Reference to a “document” as used herein may refer to, but is not limited to, any machine-readable and machine-storable work product intended for consumption by and/or rendering to a user or users at least partially in a visual manner. A document may be a file, a combination of files, one or more files with embedded links to other files, etc. The files may be of any type, such as text, images, audio, video, audiovisual, multimedia, photographs, digitally acquired content, etc. Parts of a document to be rendered to an end user can be thought of as “content” of the document. A document may include “structured data” containing both content (words, pictures, etc.) and some indication of the meaning of that content (for example, e-mail fields and associated data, HTML tags and associated data, etc.). Specific elements and/or links within the document may be defined by embedded information or instructions pointing to locations internal or external to the document. In the context of the Internet, a common document is content of a Web page. Web pages often include content and may include embedded information (such as meta information, hyperlinks, etc.) and/or embedded instructions (such as Javascript, etc.). In many cases, a document has a unique, addressable, storage location and can therefore be uniquely identified by this addressable location such as a universal resource locator (URL) for example used as a unique address used to access information on the Internet.

“Document information” as used herein may refer to, but is not limited to, any information included in the document, information derivable from information included in the document (referred to as “document derived information”), and/or information related to the document (referred to as “document related information”), as well as an extensions of such information (e.g., information derived from related information). An example of document derived information is a classification based on textual content of a document. Examples of document related information include document information from other documents with links to the instant document, as well as document information from other documents to which the instant document links.

Reference to “audiovisual content” or an item of “audiovisual element” as used herein may refer to, but is not limited to, any machine-readable and machine-storable work product intended for consumption by and/or rendering to a user or users at least partially in an audible manner. An audiovisual element may be a file, a combination of files, one or more files with embedded links to other files, etc. The files may be of any type, such as audio, image, video, multimedia, etc. Parts of an audiovisual element to be rendered to an end user can be thought of as “content” of the audiovisual element. An audiovisual element may include “structured data” containing both content (music, video, etc.) and some indication of the meaning of that content (for example, properties and associated data, HTML tags and associated data, etc.) Specific elements and/or links within the document may be defined by embedded information or instructions pointing to locations internal or external to the document. In the context of the Internet, a common audiovisual element is an element accessible via a Web page. Web pages often include audiovisual elements and may include embedded information (such as meta information, hyperlinks, etc.) and/or embedded instructions (such as JavaScript, etc.). In many cases, an audiovisual element has a unique, addressable, storage location and can therefore be uniquely identified by this addressable location such as a universal resource locator (URL) for example used as a unique address used to access information on the Internet.

“Audiovisual content information” as used herein may refer to, but is not limited to, any information included in an audiovisual element, information derivable from information included in the audiovisual element (referred to as “audiovisual element derived information”), and/or information related to the audiovisual element (referred to as “audiovisual element related information”), as well as an extensions of such information (e.g., information derived from related information). An example of audiovisual element derived information is a classification based on textual content of an audiovisual element. Examples of audiovisual element related information include audiovisual element information from other audiovisual elements with links to the instant audiovisual element, as well as audiovisual element information from other audiovisual elements to which the instant audiovisual element links.

A “HTML tag” or “tag” as used herein may refer to, but is not limited to, any non-hierarchical keyword or term assigned to a piece of information (such as an Internet bookmark, digital image, audio file or computer file). As such tags are one form of metadata that helps describe an item and allows it to be found again within standalone or networked storage systems by browsing and/or searching. Tags are generally chosen informally and personally by the item's creator or by its viewer, depending on the system and the rights associated with the item of content. As such tags form one form of metadata associated with an item of content.

“Metadata” as used herein may refer to, but is not limited to, an item of meta-information or “data about data” which may relate to an item of electronic content, audiovisual content and/or document content as well as the application(s) associated with storing, transmitting and/or rendering the content to a user. Generally, two forms of metadata are considered, namely structural metadata and descriptive metadata. Structural metadata is data about the containers of data whilst descriptive metadata uses individual instances of application data or the data content. Originally metadata was stored, for example, in the card catalogs of libraries but with the digital generation, storage, acquisition, and rendering of content metadata is now primarily referred to in respect of digital data. Metadata may be free form or it may comply to one or more metadata standards specific to a particular discipline and/or content type/format. Metadata describing the contents and context of data or data files may increase processing efficiencies within the searching, retrieval and/or rendering of content. For example, a web page may include metadata specifying what language the page is written in, the software tools employed to create it, and links or locations to additional information about the subject.

“Rendering” as used herein may refer to, but is not limited to, the process of providing to a user an item of audiovisual (AV) content. As such an item of AV content may be rendered directly as with an audio track, an image, a video, and an item of multimedia content, for example, or alternatively it may in part or in its entirety be generated from a model by a computer program and/or software application. Hence, music stored as an MP3 file, for example, may be rendered as audio to a loudspeaker(s), headphones, etc. whilst an image stored within a JPEG file, for example, may be rendered upon a display forming part of a PED and/or FED. Some AV content may be stored within a file format such as MP4 for example wherein it may be rendered from this digital multimedia format as video and/or audio according to the capabilities of the PED and/or FED it is being rendered upon.

An “overlay” as used herein may refer to, but is not limited to, a data relating to one or more items of AV content establishing one or more portions of the one or more items of AV content to be omitted or played when the associated item of AV content. Such data may be, but not limited to, a tuple of metadata, a set of tuples of metadata, and one or more tags.

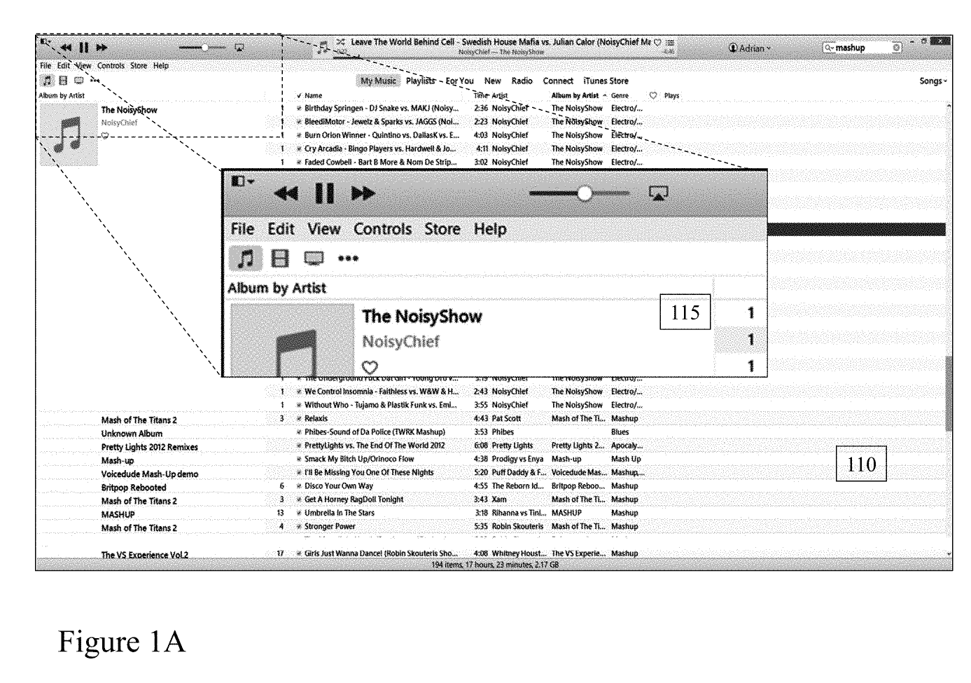

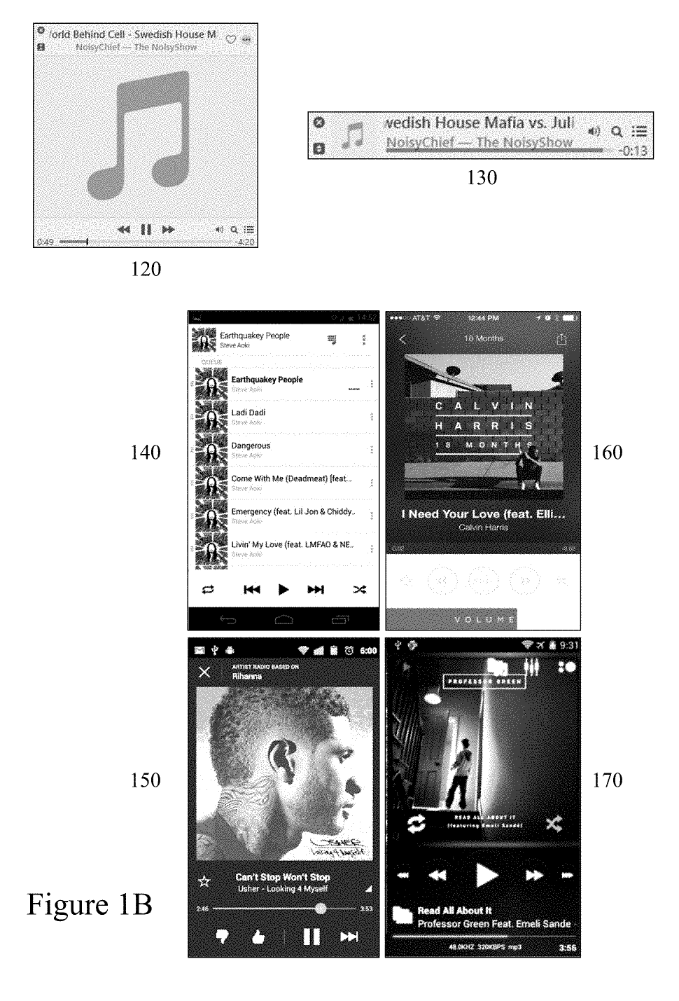

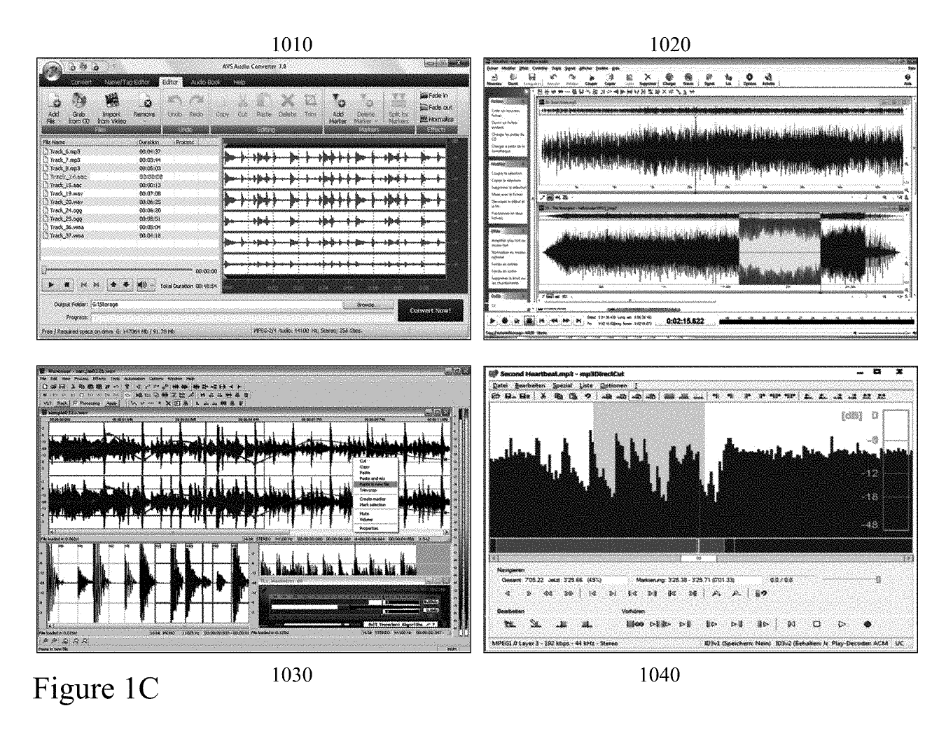

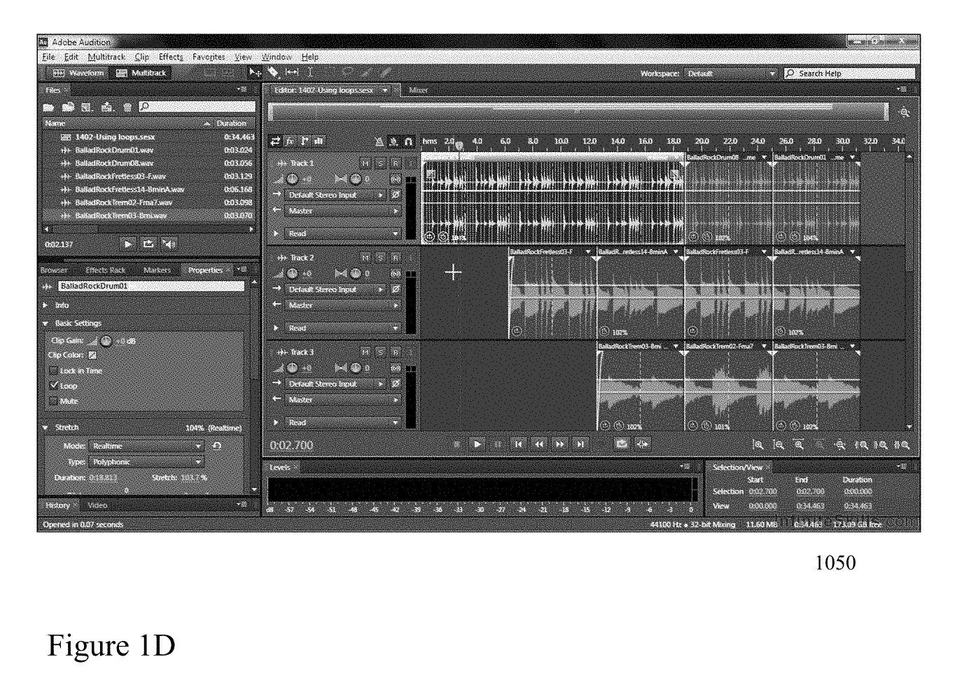

Referring to FIG. 1A there are depicted examples of prior art music players for FEDs and PEDs within the prior art as depicted within first to seventh images 110 to 170 respectively. Considering the first to third images 110 to 130 these depict respectively:
Apple™ iTunes™ upon a FED such as a laptop computer;
Apple™ iTunes™ mini-player in “large artwork” mode; and
Apple™ iTunes™ mini-player in minimized mode;

Also depicted in association with Apple™ iTunes™ in first image 110 is zoomed region 115 which depicts the player portion of the Apple™ iTunes™ whereas the remainder of the screen relates to the management of the audiovisual (AV) content either purchased through Apple™ iTunes™ or added from AV content stored upon the FED on which the Apple™ iTunes™ is in execution. Also depicted in FIG. 1 are fourth to seventh images 140 to 170 respectively representing music applications in execution upon PEDs which are respectively:
Apple™ iTunes™ application for Apple™ iOS operating system;
Spotify™ application for Android operating systems (OS);
Google™ Music for Android OS; and
Poweramp music player for Android OS.

In each instance the user is presented with the following common elements:
An identifier of the item of AV content, e.g. text identifying title of item;
A play/pause icon for triggering playing or temporarily stopping playback of the item of AV content; and
An indication of the current position of playback within the item of AV content.

Other icons or indicators may also be provided including go back to beginning, go to end, loop/replay, shuffle items of AV content, etc. Some may include, e.g. Spotify™ in fifth image 150 buttons for “like”/“dislike” which are associated with the user and therein can be associated to an overall rating of Spotify™ users. User's within some music applications, such as Spotify™ may also share AV content with friends through discrete items or playlists either through the friend's Spotify™ account or a linked social media service such as Facebook™ for example. These “like”/“dislike” features may also be used to adjust items of AV content suggested to the user or provided as part of a streaming service continuously providing AV content to the user in a manner similar to radio or television.

Referring to FIG. 1B there are depicted examples of prior art software applications for editing audio content in order to provide a user with the ability to generate a sample from an item of audio content or edit the item of audio content to generate a modified track comprising only those portions the user wishes to maintain. Examples depicted include first to fourth images 1010 to 1040 respectively of lower functionality software applications which are WavePad by NCH, AVS Audio Converter from AVS4You, Wavosaur and MP3DirectCut respectively as may be download free or at low cost. Also depicted is a higher functionality application 1050, Adobe™ Audition, which represents an example of applications that extend to audio generation and creation together with desktop audio studio management applications. Whilst audio editing software applications are depicted in FIG. 1B it would be known to one of skill in the art that corresponding software applications exist within the prior art for editing video and/or multimedia content.

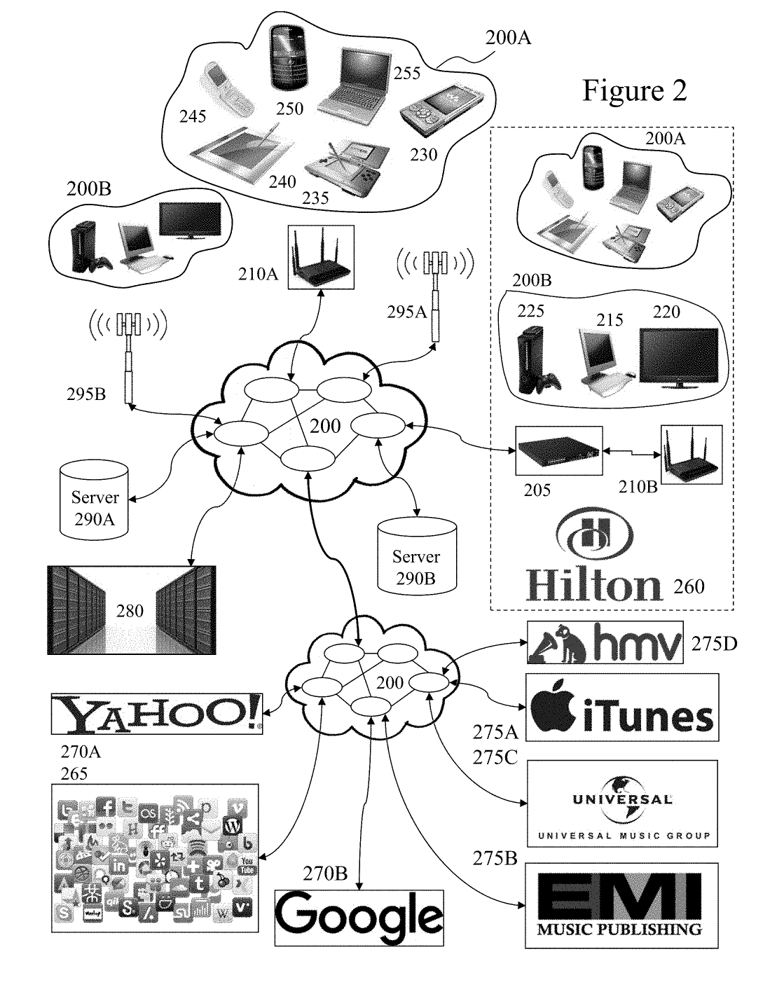

Referring to FIG. 2 there is depicted a network environment 200 within which embodiments of the invention may be employed supporting management—provisioning—distribution of AV content via AV content Systems and Provisioning Applications/Platforms (AVSPAPs) according to embodiments of the invention. Such AVSPAPs, for example supporting multiple channels and dynamic content. As shown first and second user groups 200A and 200B respectively interface to a telecommunications network 200. Within the representative telecommunication's architecture, a remote central exchange 280 communicates with the remainder of a telecommunication service providers network via the network 200 which may include for example long-haul OC-48/OC-192 backbone elements, an OC-48 wide area network (WAN), a Passive Optical Network, and a Wireless Link. The central exchange 280 is connected via the network 200 to local, regional, and international exchanges (not shown for clarity) and therein through network 200 to first and second cellular APs 295A and 295B respectively which provide Wi-Fi cells for first and second user groups 200A and 200B respectively. Also connected to the network 200 are first and second Wi-Fi nodes 210A and 210B, the latter of which being coupled to network 200 via router 205. Second Wi-Fi node 210B is associated with Enterprise 260, e.g. Hilton Hotels™, within which other first and second user groups 200A and 200B are disposed. Second user group 200B may also be connected to the network 200 via wired interfaces including, but not limited to, DSL, Dial-Up, DOCSIS, Ethernet, G.hn, ISDN, MoCA, PON, and Power line communication (PLC) which may or may not be routed through a router such as router 205.

Within the cell associated with first AP 210A the first group of users 200A may employ a variety of PEDs including for example, laptop computer 255, portable gaming console 235, tablet computer 240, smartphone 250, cellular telephone 245 as well as portable multimedia player 230. Within the cell associated with second AP 210B are the second group of users 200B which may employ a variety of FEDs including for example gaming console 225, personal computer 215 and wireless/Internet enabled television 220 as well as cable modem 205. First and second cellular APs 295A and 295B respectively provide, for example, cellular GSM (Global System for Mobile Communications) telephony services as well as 3G, 3GPP, 4G and 5G evolved services with enhanced data transport support etc. Second cellular AP 295B provides coverage in the exemplary embodiment to first and second user groups 200A and 200B. Alternatively the first and second user groups 200A and 200B may be geographically disparate and access the network 200 through multiple APs, not shown for clarity, distributed geographically by the network operator or operators. First cellular AP 295A as show provides coverage to first user group 200A and environment 270, which comprises second user group 200B as well as first user group 200A. Accordingly, the first and second user groups 200A and 200B may according to their particular communications interfaces communicate to the network 200 through one or more wireless communications standards such as, for example, IEEE 802.11, IEEE 802.15, IEEE 802.16, IEEE 802.20, UMTS, UMTS, GSM/LTE 850, GSM/LTE 900, GSM/LTE 1800, GSM/LTE 1900, GPRS, LTE, ITU-R 5.138, ITU-R 5.150, ITU-R 5.280, and IMT-2000. It would be evident to one skilled in the art that many portable and fixed electronic devices may support multiple wireless protocols simultaneously, such that for example a user may employ GSM services such as telephony and SMS and Wi-Fi/WiMAX data transmission, VOIP and Internet access. Accordingly, portable electronic devices within first user group 200A may form associations either through standards such as IEEE 802.15 and Bluetooth as well in an ad-hoc manner.

Also connected to the network 200 are Social Networks (SOCNETS) 265, first and second web based service providers 270A and 270B respectively, e.g. Yahoo™ and Google™, and first to third party providers 275A to 275D respectively, e.g. Apple™ iTunes (a downloaded software application provider relating to audiovisual content purchasing and/or management), EMI™ (a producer of audiovisual content), Universal's (a producer of audiovisual content), and HIVIV™ (a web and brick based retailer of audiovisual content) as well as first and second servers 290A and 290B which together with others, not shown for clarity. First and second servers 290A and 290B may host according to embodiments of the inventions multiple services associated with a provider of advertising systems and publishing applications/platforms (AVSPAPs); a provider of a SOCNET or Social Media (SOME) exploiting AVSPAP features; a provider of a SOCNET and/or SOME not exploiting AVSPAP features; a provider of services to PEDS and/or FEDS; a provider of one or more aspects of wired and/or wireless communications; an Enterprise 260 exploiting AVSPAP features; license databases; content databases; image databases; content libraries; customer databases; websites; and software applications for download to or access by FEDs and/or PEDs exploiting and/or hosting AVSPAP features. First and second primary content servers 290A and 290B may also host for example other Internet services such as a search engine, financial services, third party applications and other Internet based services.

Accordingly, a consumer and/or customer (hereinafter a user) may exploit a PED and/or FED within an Enterprise 260, for example, and access one of the first or second primary content servers 290A and 290B respectively to perform an operation such as accessing/downloading an application which provides AVSPAP features according to embodiments of the invention; execute an application already installed providing AVSPAP features; execute a web based application providing AVSPAP features; or access content. Similarly, a user may undertake such actions or others exploiting embodiments of the invention exploiting a PED or FED within first and second user groups 200A and 200B respectively via one of first and second cellular APs 295A and 295B respectively and first Wi-Fi nodes 210A.

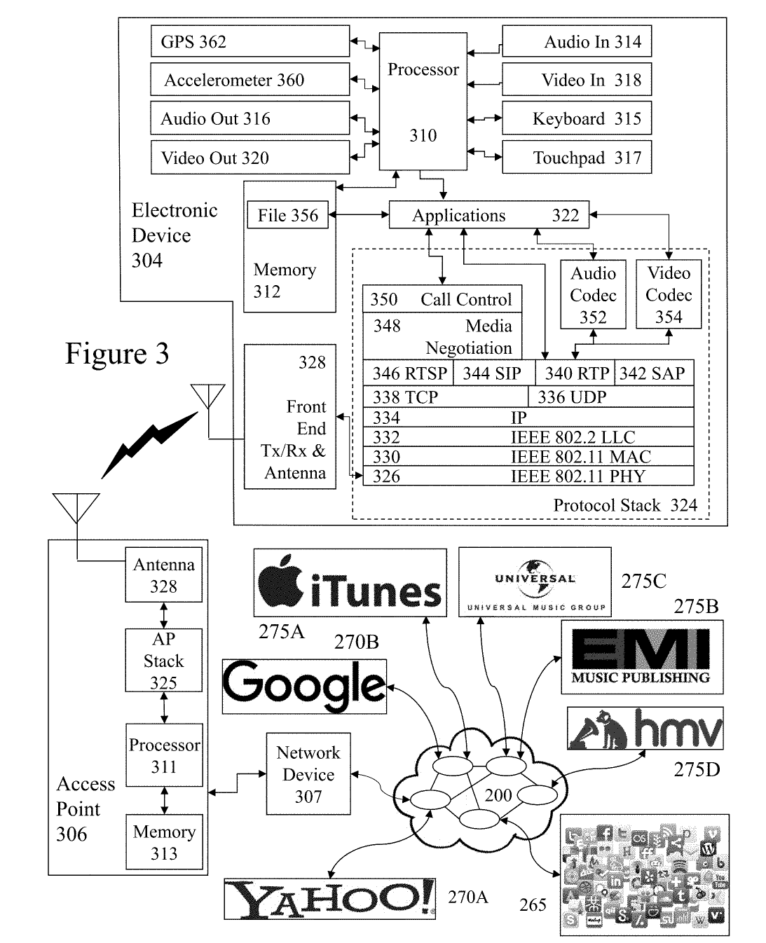

Now referring to FIG. 3 there is depicted an electronic device 304 and network access point 307 supporting AVSPAP features according to embodiments of the invention. Electronic device 304 may, for example, be a PED and/or FED and may include additional elements above and beyond those described and depicted. Also depicted within the electronic device 304 is the protocol architecture as part of a simplified functional diagram of a system 300 that includes an electronic device 304, such as a smartphone 255, an access point (AP) 306, such as first AP 210, and one or more network devices 307, such as communication servers, streaming media servers, and routers for example such as first and second servers 290A and 290B respectively. Network devices 307 may be coupled to AP 306 via any combination of networks, wired, wireless and/or optical communication links such as discussed above in respect of FIG. 2 as well as directly as indicated. Network devices 307 are coupled to network 300 and therein Social Networks (SOCNETS) 265, first and second web based service providers 270A and 270B respectively, e.g. Yahoo™ and Google™, and first to third party providers 275A to 275D respectively, e.g. Apple™ iTunes (a downloaded software application provider relating to audiovisual content purchasing and/or management), EMI™ (a producer of audiovisual content), Universal's (a producer of audiovisual content), and HMV™ (a web and brick based retailer of audiovisual content) as well as first and second servers 290A and 290B.

The electronic device 304 includes one or more processors 310 and a memory 312 coupled to processor(s) 310. AP 306 also includes one or more processors 311 and a memory 313 coupled to processor(s) 310. A non-exhaustive list of examples for any of processors 310 and 311 includes a central processing unit (CPU), a digital signal processor (DSP), a reduced instruction set computer (RISC), a complex instruction set computer (CISC) and the like. Furthermore, any of processors 310 and 311 may be part of application specific integrated circuits (ASICs) or may be a part of application specific standard products (ASSPs). A non-exhaustive list of examples for memories 312 and 313 includes any combination of the following semiconductor devices such as registers, latches, ROM, EEPROM, flash memory devices, nonvolatile random access memory devices (NVRAM), SDRAM, DRAM, double data rate (DDR) memory devices, SRAM, universal serial bus (USB) removable memory, and the like.

Electronic device 304 may include an audio input element 314, for example a microphone, and an audio output element 316, for example, a speaker, coupled to any of processors 310. Electronic device 304 may include a video input element 318, for example, a video camera or camera, and a video output element 320, for example an LCD display, coupled to any of processors 310. Electronic device 304 also includes a keyboard 315 and touchpad 317 which may for example be a physical keyboard and touchpad allowing the user to enter content or select functions within one of more applications 322. Alternatively, the keyboard 315 and touchpad 317 may be predetermined regions of a touch sensitive element forming part of the display within the electronic device 304. The one or more applications 322 that are typically stored in memory 312 and are executable by any combination of processors 310. Electronic device 304 also includes accelerometer 360 providing three-dimensional motion input to the process 310 and GPS 362 which provides geographical location information to processor 310.

Electronic device 304 includes a protocol stack 324 and AP 306 includes a communication stack 325. Within system 300 protocol stack 324 is shown as IEEE 802.11 protocol stack but alternatively may exploit other protocol stacks such as an Internet Engineering Task Force (IETF) multimedia protocol stack for example. Likewise, AP stack 325 exploits a protocol stack but is not expanded for clarity. Elements of protocol stack 324 and AP stack 325 may be implemented in any combination of software, firmware and/or hardware. Protocol stack 324 includes an IEEE 802.11-compatible PHY module 326 that is coupled to one or more Front-End Tx/Rx & Antenna 328, an IEEE 802.11-compatible MAC module 330 coupled to an IEEE 802.2-compatible LLC module 332. Protocol stack 324 includes a network layer IP module 334, a transport layer User Datagram Protocol (UDP) module 336 and a transport layer Transmission Control Protocol (TCP) module 338.

Protocol stack 324 also includes a session layer Real Time Transport Protocol (RTP) module 340, a Session Announcement Protocol (SAP) module 342, a Session Initiation Protocol (SIP) module 344 and a Real Time Streaming Protocol (RTSP) module 346. Protocol stack 324 includes a presentation layer media negotiation module 348, a call control module 350, one or more audio codecs 352 and one or more video codecs 354. Applications 322 may be able to create maintain and/or terminate communication sessions with any of devices 307 by way of AP 306. Typically, applications 322 may activate any of the SAP, SIP, RTSP, media negotiation and call control modules for that purpose. Typically, information may propagate from the SAP, SIP, RTSP, media negotiation and call control modules to PHY module 326 through TCP module 338, IP module 334, LLC module 332 and MAC module 330.

It would be apparent to one skilled in the art that elements of the electronic device 304 may also be implemented within the AP 306 including but not limited to one or more elements of the protocol stack 324, including for example an IEEE 802.11-compatible PHY module, an IEEE 802.11-compatible MAC module, and an IEEE 802.2-compatible LLC module 332. The AP 306 may additionally include a network layer IP module, a transport layer User Datagram Protocol (UDP) module and a transport layer Transmission Control Protocol (TCP) module as well as a session layer Real Time Transport Protocol (RTP) module, a Session Announcement Protocol (SAP) module, a Session Initiation Protocol (SIP) module and a Real Time Streaming Protocol (RTSP) module, media negotiation module, and a call control module. Portable and fixed electronic devices represented by electronic device 304 may include one or more additional wireless or wired interfaces in addition to the depicted IEEE 802.11 interface which may be selected from the group comprising IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-2000, DSL, Dial-Up, DOCSIS, Ethernet, G.hn, ISDN, MoCA, PON, and Power line communication (PLC).

Within the examples of prior art media players, the features provided to the user through the AVSPAP treat an item of AV content as a discrete item. Accordingly, Spotify™ with a “like”/“dislike” requires the user to provide a single summary assessment of their liking or disliking of the item of AV content. However, the user's perception may in many instances be hard to summarise in that they may like the introductory section and the chorus but dislike the verses. Similarly, identifying the item of content to a friend within these applications through like, sharing, or linking for example is simply to the entire item. The sole exception to the inventor's knowledge within prior art audio players is within Spotify™ wherein a user may share a link/reference to an item of AV content through selecting the text of a link to the item of AV content and adding text within an application they are sending the link with indicating a start time within the item of AV content. Then if the recipient employs the link within Spotify™ the track will begin at the point the sender has identified.

The only alternative within the prior art is for the user to employ an AV content editor such as described and depicted in respect of FIG. 1B for audio content or corresponding applications for video and/or multimedia content. In this manner the user generates a new item of AV content from the original item of AV content. However, in most instances of commercially released AV content the user does not have the right to edit, amend, re-distribute etc. the AV content without permission from the owner of the AV content. Further, such AV content editing requires the user to employ additional software external to the AV content player they employ and spend significant time and effort to generate the new item to send to their friend(s) etc.

As such, there is no methodology known to the inventors within these AV content players and/or management—purchase applications for a user to define one or more portions of the item of AV content, for example through the association of markers (hereinafter referred to as “tags”), which is then stored and may be employed in association with the item of AV content to provide either the user or another user with functionality. Such tags in pairs, e.g. a start tag and an end, define portions of the AV content with different functionality to others. As these “tags” are associated with an item of AV content but as will be evident from the following description are not embedded within the item of AV content then these tags define what the inventors refer to as an overlay to the item of AV content and it will become further evident that multiple overlays may be associated with a single item of AV content. The tags/overlay provide the user or another user with functionality including, but not limited to, the following:
Only playing the tagged portion(s);
Skipping the tagged portion(s);
Associating sentiments to the tagged portion(s) such as like, love, dislike, hate, etc.;
Associating the tagged portion(s) to another item of AV content.

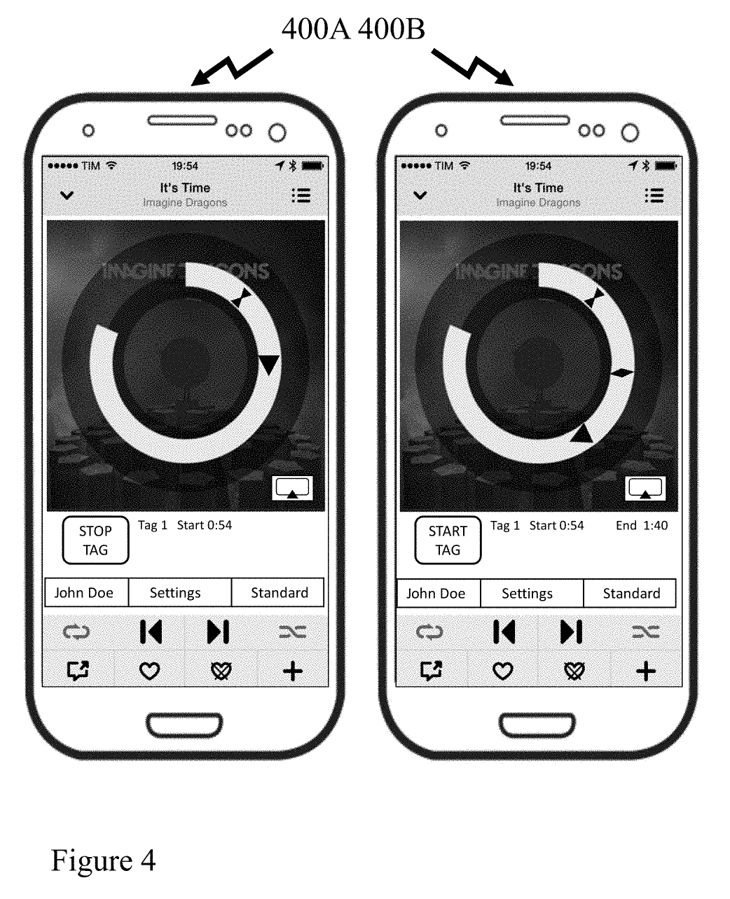

Accordingly, as will become evident from the descriptions below in respect of FIGS. 4 to 10, these features can be supported within AV applications on PEDs and/or FEDs without affecting or editing the underlying AV thereby providing users with an ease of use and/or functionality not achievable from the prior art software applications. The tag(s) associated to an item of AV content may be viewed as an overlay as they do not amend the underlying AV content whilst supporting modification of the playback of the item of AV content when enabled/selected etc. by the user. Accordingly, as will be evident from the following description this overlay or these overlays allow for a higher level of specificity as to what a user wishes to listen and/or view than prior art software applications and methodologies. Further, these overlays allow for additional levels of automation, specification, crowd polling, recommendations, etc.

Referring to FIG. 4 there are depicted first and second simulated screenshots 400A and 400B respectively of an application in execution upon a portable electronic device according to an embodiment of the invention for a user tagging an item of audiovisual content. Considering first simulated screenshot (SIMSCR) 400A a user is exploiting an AVSPAP according to an embodiment of the invention where they are playing “It's Time” by Imagine Dragons™ as displayed in upper portion of the screen which also includes a menu icon. At the bottom of the SIMSCR 400A there are three rows, two of icons and one of buttons. The upper row of icons, left to right, relate to looping the track, going back to the start of the track, going to the end of track, and shuffling tracks rather than sequentially progressing from the current track to the next. The lower row of icons comprising icons for adding a comment, liking the track, disliking the track, and adding it to a favorites list.

The row of buttons being user identity, currently depicted as “John Doe”, settings, and AVPSAP configuration, currently depicted as “Standard.” Accordingly, the user can through the settings change not only aspects relating to the display, tags, etc. as discussed below but also change their “identity” and access advanced features, for example, established in dependence upon a subscription to the AVPSAP. It is assumed within these descriptions that the AVPSAP is linked to the user's social media such that their identity (identities) are linked to the AVPSAP such that, for example, the AVPSAP automatically associates the series of tags (or single tag) forming an overlay to the current identity (identities). Alternatively, no associations may be made within other embodiments of the invention or no associations are made by default but can be made by the user subsequently temporarily or until amended. An AVPSAP may be, for example, distributed free providing users with a first feature set but may be extended through purchase, subscription, etc. to “unlock” or provide access to additional features. The titles of these may vary and those used within the embodiments of the invention depicted and described within this specification are not intended to be indicative but merely an example. As such the “standard” depicted may within some embodiments of the invention be associated with a free version whilst in others with a standard AVPSAP purchase or subscription, for example.

Above these 3 rows are two regions, the first with a “Stop Tag” button (as the user has already indicated a start) and an indication of currently established tags, e.g. “Tag 1 Start 0:54”, and the second with an annular “duration” ring relating to the track showing the current play position, the triangular icon, and “start” tag depicted by a pair of triangles touching point-to-point.

Subsequently, in second SIMSCR 400B the user has selected the “Stop Tag” button displayed in first SIMSCR 400A such that the button now reverts to “Start Tag” and the indication adjacent to it is “Tag 1 Start 0:54 End 1:40.” The current play position, the triangular icon, has moved further around the annular “duration” ring and now in addition to the “start” tag depicted by a pair of triangles touching point-to-point there is a “stop” tag depicted by a pair of triangles touching base-base. It would be evident that other markers may be employed to indicate start and stop tags whilst these may be linked to denote a segment within the AV content which will be played. Optionally, the start and stop tags may be employed in conjunction with other depictions of the AV content duration including linear, circular, polygonal, geometric, non-geometric etc. For example, a linear track may be depicted with one colour for the portion of the content currently played so far and another colour to depict a portion either tagged or being tagged. These features may be set as setting options within the AVSPAP. Similarly, the indications of tagged segments in textual form may be omitted, displayed or set via user setting etc. within the AVSPAP. Representations may be linear as well as non-linear with respect to displayed icon positions and time position within the AV content.

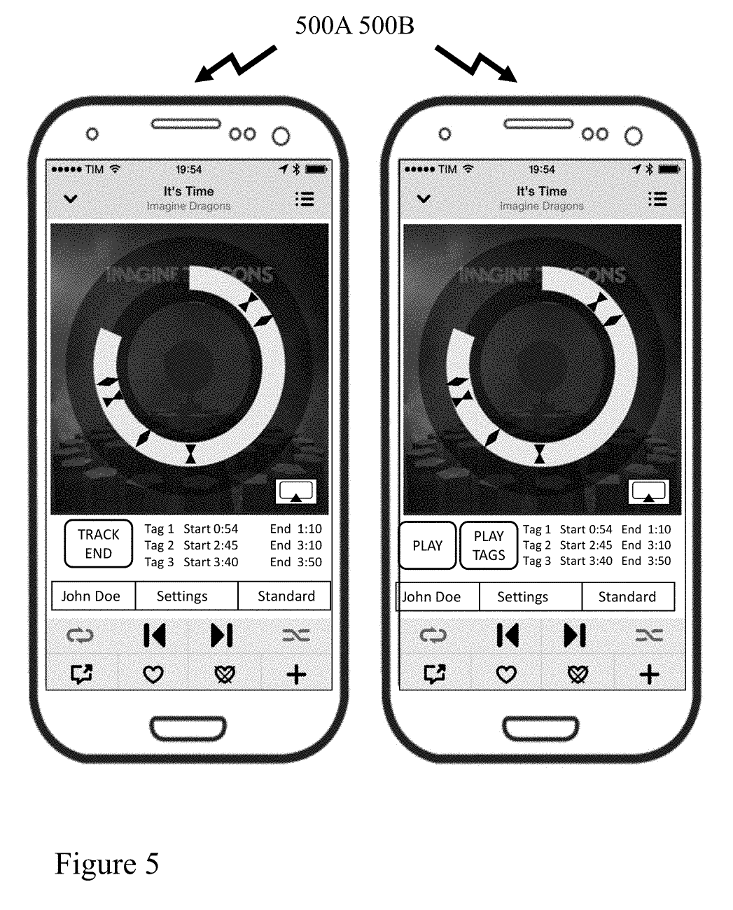

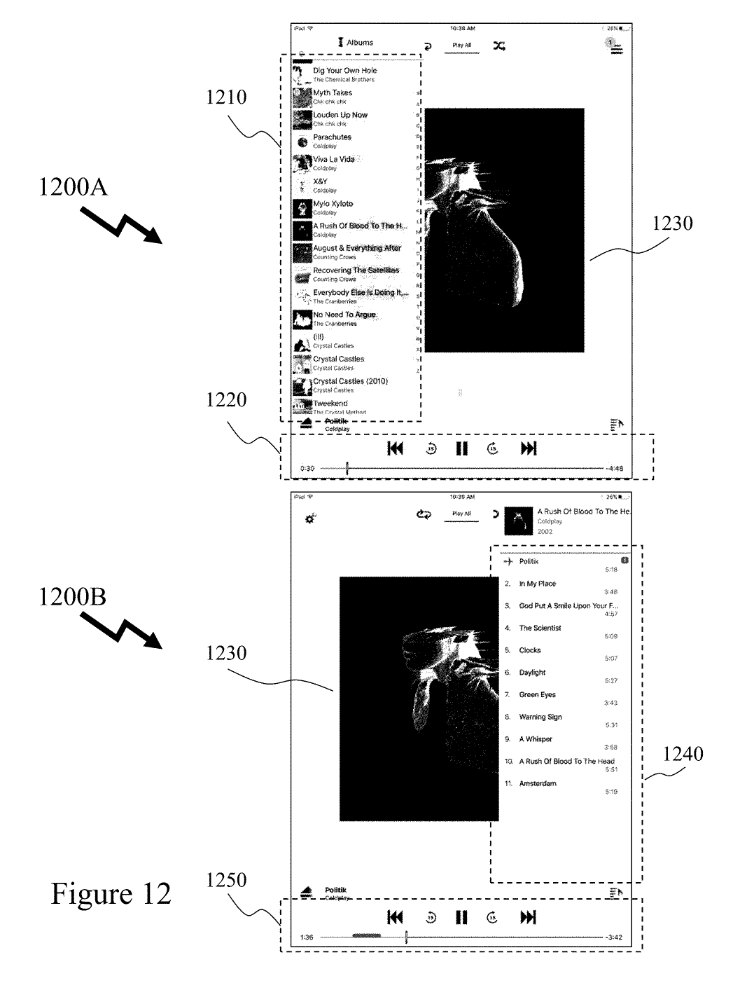

Referring to FIG. 5 there are depicted first and second SIMSCR 500A and 500B respectively of an application in execution upon a portable electronic device according to an embodiment of the invention for a user tagging an item of audiovisual content. It would be evident to one of skill that the graphical user interface (GUI), buttons and/or other elements etc. providing the user with the ability to define tags and overlays with respect to an item of AV content may be of multiple different designs according to the design aesthetic of the GUI, electronic device, device manufacturers, AVPSAP provider etc. as well as configured according to a user's preferences. For example, in FIGS. 4 to 6 one such GUI methodology is presented whilst in FIGS. 12 to 14 another GUI methodology is presented. Optionally, within other embodiments of the invention a user may select a theme for their GUI according to their preferences or may purchase/download one or more GUI “skins” to customize the AVPSAP beyond those installed on the device at purchase or AVPSAP installation. Each GUI, however, provides a series of basic functions which may broadly be described as allowing the use to select a starting point, e.g. a start tag or overlay start; to select a stopping point, e.g. a stop tag or overlay stop (end); store the tags/overlay, and use tags and/or overlay in combination with the item of AV content.

Accordingly, referring to FIG. 5 and considering first SIMSCR 500A a user is exploiting an AVSPAP according to an embodiment of the invention where they are playing “It's Time” by Imagine Dragons™ as displayed in upper portion of the screen which also includes a menu icon and has now completed playing the item of AV content and establishing tags with it. Accordingly, the user has tagged three portions:

| | | | | |
|---|---|---|---|---|
| Tag 1 | Start | 0:54 | End | 1:10 |
| Tag 2 | Start | 2:45 | End | 3:10 |
| Tag 3: | Start | 3:40 | End | 3:50 |

As indicated the button to the left of these now shows that the AV content being played has ended, i.e. completed playback without either the track looping or proceeding to the next item of AV content within a playlist, for example. Optionally, the user within the AVPSAP may edit the start/end tags through one or more interfaces known within the art including, but not limited to, a text editor, graphical user interface with “drag-and-drop”, etc.

Subsequently, as depicted in second SIMSCR 500B the user has accessed the item of AV content discretely, or as part of a playlist for example, wherein the set of tags comprising the overlay are both listed and displayed together with two buttons, “Play” and “Play Tags.” The former plays and/or renders the item of AV content to the user in the standard normal manner of prior art media players. However, the latter results in only those portions that have been tagged being played and/or rendered.

Optionally, within embodiments of the invention the user may within settings toggle the overlay functionality such that those portions tagged are not played or the full track is played with audible and/or visual indications of when each start tag/end tag is encountered. Optionally, within embodiments of the invention a user having rendered an item of AV content and returning to it to tag it may establish a configuration tag such that the AVPSAP reads the configuration tag and therefore knows whether the tags therefore define what to skip or what to render (e.g. play, display, etc.). Optionally, within embodiments of the invention a user may establish start and stop tags during rendering of an item of AV content and upon completion of the rendering or per set of tags be asked to determine whether they relate to content being ignored or to be rendered in subsequent renderings with that overlay of tags.

Optionally, the overlay may be one context such as render, for example, wherein if the user has selected regions of the item of AV content as to be ignored the AVPSAP upon storing of the overlay generates the stored overlay in dependence upon the overlay the user has established. For example, if a 60 second item has been tagged by the user such that the period from 20 seconds to 30 seconds is to be skipped, e.g. the overlay generated during rendering may be structured as given by Equation (1) then the actual stored overlay may be as given in Equation (2).

$$\begin{matrix}Create ( Tag ; Start ; End ; Display ) = ( 1 ; 0 \text{:} 20 ; 0 \text{:} 30 ; - 1 ) & ( 1 ) \\ Store ( Tag ; Start ; End ; Display ) = \begin{matrix}( 1 ; & 0 \text{:} 00 ; & 0 \text{:} 20 ; & + 1 ) \\ ( 2 ; & 0 \text{:} 30 ; & 0 \text{:} 60 ; & + 1 )\end{matrix} & ( 2 )\end{matrix}$$

Accordingly, an overlay or set of tags comprises one or more sets of associated metadata which include an association to an item of AV content. The overlay may within embodiments of the invention be bound to the item of AV content or within other embodiments be stored with identifying associations of the AV content. In the former the AV content and overlay must be transmitted whereas in the latter only the overlay need be transmitted. Optionally, a media player/AVPSAP may be provided with one or more items of AV content to render to the user (e.g. a playlist) wherein it checks when retrieving an item of content to render whether an overlay exists for the item and employs it if the settings of the media player/AVPSAP are set to automatically employ them or it may prompt that an overlay exists and whether to use it or not. Alternatively, an item or playlist of AV content may be established from the overlay(s) wherein the media player/AVPSAP retrieves or accesses the item of content for each overlay in sequence. Accordingly, a playlist may be established on a PED with an overlay playlist such that each item is then accessed in sequence into memory and then rendered based upon the overlay(s). In some embodiments of the invention the AVPSAP may be within a PED with low memory such that, for example, only the currently rendering item and the next item are stored.

The metadata, for example text base tags, allows for simple parsing but also for simple text based editing/modification. The data may be represented as JavaScript Object Notation (JSON), Extensible Markup Language (XML), or any other text-based method. Text based tags may for example be denoted in binary notation. The metadata consists of information external to the item of AV content and may consist of a set of tuples. Each tuple, an ordered finite list of elements, may be of the format described and depicted within the embodiments of the invention with respect to FIGS. 4 to 10 such that it comprises, an identifier to the tag (tuple set), a start time (t_{START}), an end time (t_{END}), and a sign. Alternatively, it may be the identifier, t_{START} duration (t_{END}−t_{START}), and an indicator (render/skip).

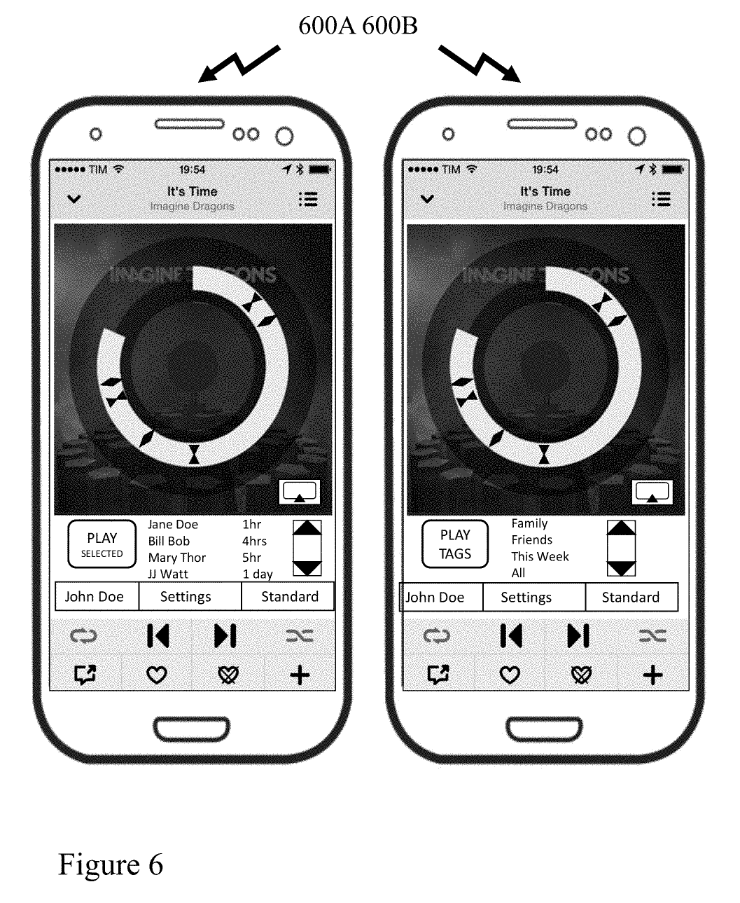

Now referring to FIG. 6 there are depicted first and second SIMSCR 600A and 600B respectively of an application in execution upon a portable electronic device according to an embodiment of the invention for a user playing audiovisual content based upon metadata tags provided by individuals or social networks. Referring to first SIMSCR 600A a user is exploiting an AVSPAP according to an embodiment of the invention where they have selected “It's Time” by Imagine Dragons™ for rendering as displayed in upper portion of the screen. Now the region above the button toolbars displays a list of names with times, e.g. “Jane Doe 1 hr”, “Bill Bob 4 hrs”, and “Mary Thor 5 hrs.” Also depicted are scroll icon and “Play Selected” button. Each name within the list presented is, for example, associated with a member of one or more social networks the user has “friended” or otherwise linked to their profile upon the one or more social networks and has then associated the social network(s) with their profile with an AVPSAP by the user.

Optionally, the user may be presented with filtering options or navigation options so that they may, for example, restrict the displayed names to one specific social network, e.g. Facebook™. Optionally, a depicted in second SIMSCR 600B the user may select a category of contacts. For example, those depicted being family, friends, all contacts putting an overlay to the item of AV content within the last week, and all. Accordingly, a user may access overlays established by another user shared through a social network associated with an ADPSAP according to an embodiment of the invention. Alternatively, an overlay may be transmitted to a user, stored within memory, and retrieved by the AVPSAP when the user selects the AV content to which the overlay relates. For example, an overlay may be an attachment in an electronic mail, uploaded/downloaded to remote storage, uploaded/downloaded to cloud based storage, etc. Accordingly, an overlay or overlays and their metadata may be locally and/or externally both in association with and/or independent of the AVPSAP. Such storage may include a database, a text file, spreadsheet, HTML file, etc.

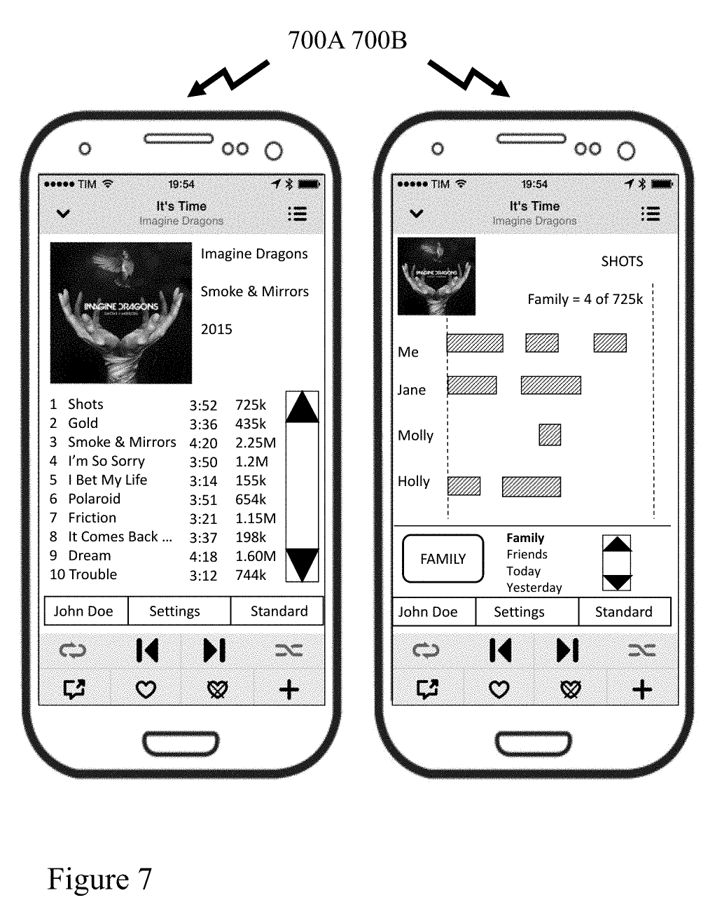

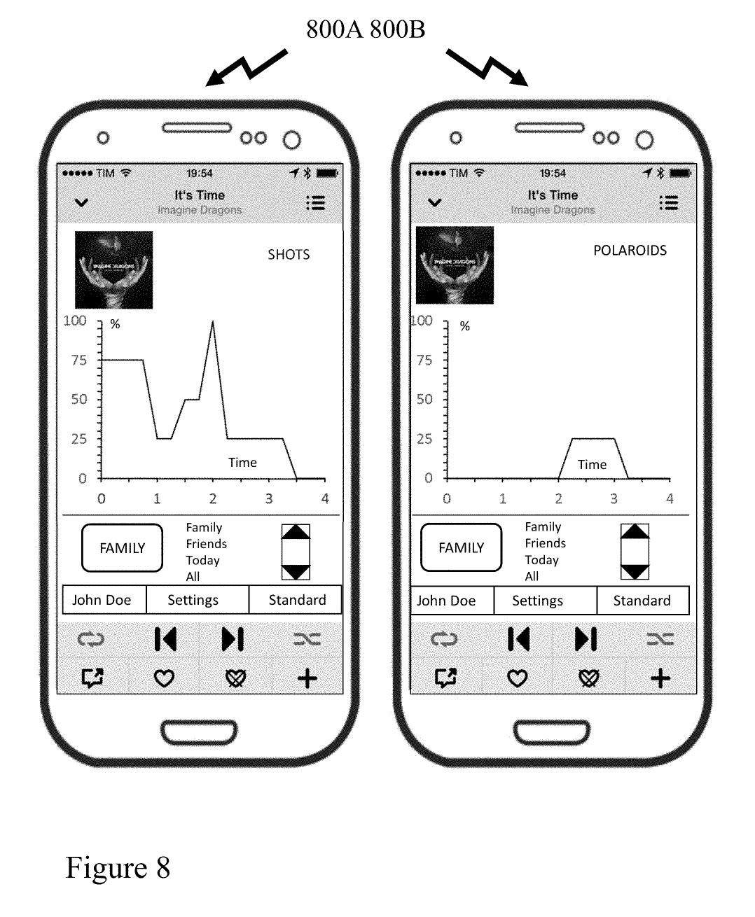

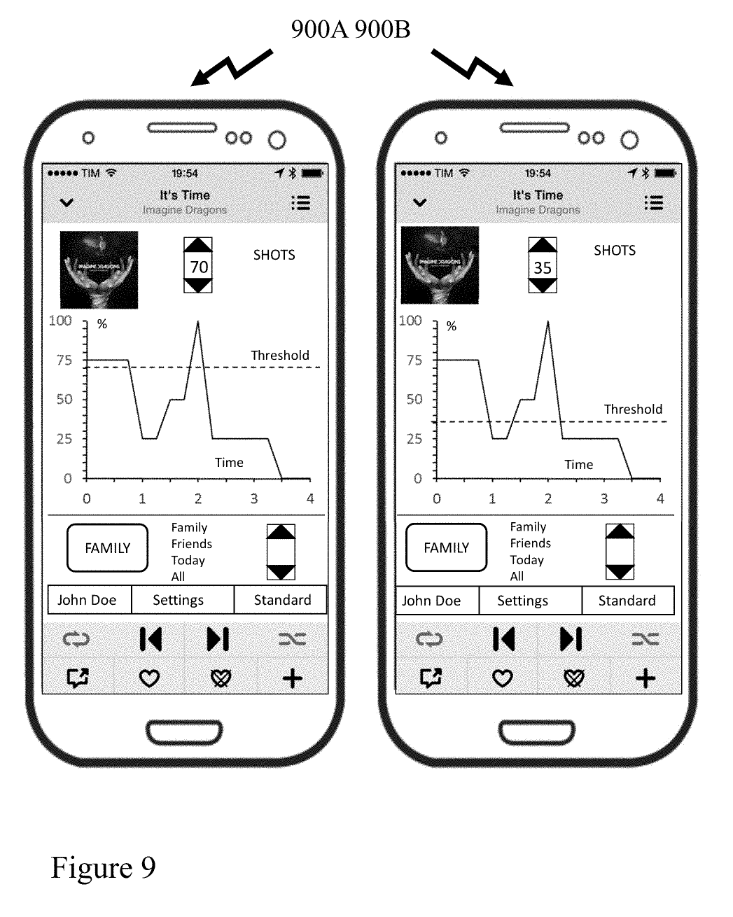

Referring to FIG. 7 depicts there are depicted first and second SIMSCR 400A and 400B respectively of an application in execution upon a portable electronic device according to an embodiment of the invention for a user viewing a collection of audiovisual content and metadata tagged elements selected by a social network. Referring to first SIMSCR 700A the user has selected “Smoke & Mirrors” the 2015 album released by “Imagine Dragons.” Accordingly, the accessing of the album within the AVPSAP results in the user being presented with a track listing where in addition to the track number, track name, and track time there is an indication of the number of overlays associated with each track within the users of the AVPSAP, for example. Accordingly, the user may elect to play a track, e.g. “Shots” which has approximately 725,000 overlays associated with it wherein the portion of the track played is based upon the collective metadata of those users such as described and depicted in respect of FIGS. 8 and 9.

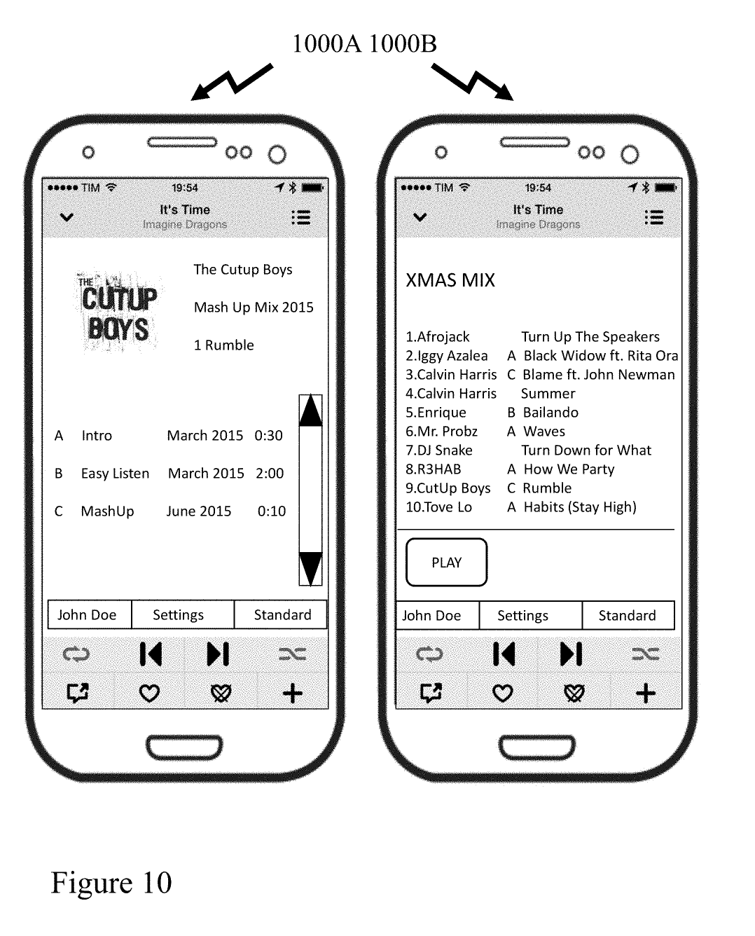

Within second SIMSCR 700B the user within the AVPSAP is presented with filtering options for a track, tracks, album, playlist selected for rendering. For example, the user has selected the track “Shots” and the filter “Family” resulting in them being presented 4 overlays out of the approximately 725,000. It would be evident that a wide variety of filters may be established based upon, but not limited to, social network, degree of separation from user, date, number of renderings by other users, etc. in order to reduce what may be a large number of overlays established by users in respect of a popular item of AV content. However, with a filter such as family the number of overlays may be typically small, although as evident from first SIMSCR 1000A in FIG. 10 each user may generate multiple overlays to a single track. Accordingly, in second SIMSCR 700A the user is presented with the overlays generated by themselves (“Me”), “Jane”, “Molly”, and “Holly” and may as discussed below in respect of FIGS. 8 and 9 render the AV content based on the selection of one overlay, based upon a filter applied to an overlay, based upon multiple overlays, or a filter applied to multiple overlays for example.

Now referring to FIG. 8 there are depicted first and second SIMSCR 800A and 800B respectively of an application in execution upon a portable electronic device according to an embodiment of the invention for a user viewing audiovisual elements and their collated metadata tags. Whilst a user may establish a tag to within a predetermined time, e.g. 1 second, within embodiments of the invention when these overlays are displayed and/or combined they may be “rounded” to a different time frame according to a characteristic of the AV content for example although other characteristics relating to the AVPSAP, user's profile, user's subscription, etc. For example, an audio file may be “rounded” to predetermined intervals such as 5 seconds, 10 seconds, or 15 seconds whilst a movie may be “rounded” to different predetermined intervals such as 30 seconds, 1 minute, 2 minutes or 5 minutes for example. Such “rounding” may be employed when displaying collated overlays from all users of an AVPSAP, for example, or subsets such as friends, family, those added today, etc. Such a display is depicted in first SIMSCR 800A wherein the overlays from the four users in second SIMSCR 700B have been collated and normalized using a predetermined interval of 15 seconds. Optionally, instead of rounding to a time based aspect of the item of AV content then the rounding may be to a beat of the song such that the start/stop is aligned with the beat of the AV content.

Accordingly assigning a score of 1 to a time slot with the AV content playing, e.g. any tag to start playing within the time period {0:00; 0:15}, and a 0 to the score when the AV content is not playing results in the individual score lines for each user in Table 1 which are then summed to yield the totals also depicted in Table 1 and which are plotted within the display in first SIMSCR 800A. Second SIMSCR 800B depicts the same analysis for the track “Polaroids” which is also taken from the same album, “Smoke & Mirrors,” indicating that in comparison only one overlay of the four comprised a section to be played.

It would be evident that a user who does not create an overlay may still like an item of AV content or they may dislike it. Accordingly, within other embodiments of the invention any scoring may be weighted by one or more factors including, for example, whether the user has “liked” or “disliked” the item of AV content or normalizing the number of overlays by the number of users who played the track, etc.

TABLE 1
Individual User Scores and Collated Scores

| User | Time | | | | | | | | | | | | | | | | |
|---|---|---|---|---|---|---|---|---|---|---|---|---|---|---|---|---|---|
| Me | 1 | 1 | 1 | 1 | 0 | 0 | 1 | 1 | 0 | 0 | 0 | 1 | 1 | 1 | 0 | 0 | 0 |
| Jane | 1 | 1 | 1 | 1 | 0 | 0 | 1 | 1 | 1 | 1 | 1 | 0 | 0 | 0 | 0 | 0 | 0 |
| Molly | 0 | 0 | 1 | 1 | 0 | 0 | 0 | 1 | 1 | 0 | 0 | 0 | 0 | 0 | 0 | 0 | 0 |
| Holly | 1 | 1 | 0 | 0 | 1 | 1 | 0 | 1 | 1 | 0 | 0 | 0 | 0 | 0 | 0 | 0 | 0 |
| Total | 3 | 3 | 3 | 3 | 1 | 1 | 2 | 4 | 4 | 1 | 1 | 1 | 1 | 1 | 0 | 0 | 0 |
| Normalized (%) | 75 | 75 | 75 | 75 | 25 | 25 | 50 | 50 | 100 | 25 | 25 | 25 | 25 | 25 | 0 | 0 | 0 |

Referring to FIG. 9 there are depicted first and second SIMSCR 900A and 900B respectively of an application in execution upon a PED according to an embodiment of the invention for a user viewing an audiovisual element with its collated metadata tags and playing portions of the audiovisual element exceeding a threshold. Accordingly, within each of the first and second SIMSCR 900A and 900B the same results as depicted in first SIMSCR 800A are presented with thresholds displayed set at 70% and 35% respectively. Accordingly, the user can adjust the threshold and accordingly the portion of the AV content played varies as this threshold is adjusted. In the instance that the overlays define the portion of the item of AV content to be rendered then setting the threshold to 0% is equivalent to playing the entire item of AV content.

Now referring to FIG. 10 there are depicted first and second SIMSCR 1000A and 1000B respectively of an application in execution upon a PED according to an embodiment of the invention for a user viewing multiple metadata tag filters associated with the audiovisual element and a playlist based upon a sequence of metadata tagged audiovisual elements. Within first SIMSCR 1000A a user has accessed an item of AV content, an audio track “Rumble” by “The Cutup Boys,” which has associated with it for the user three overlays, “Intro”, “Easy Listen”, and “MashUp.” Accordingly, the user can select each individually or as depicted in second SIMSCR 1000B include one of these overlays within a playlist “Xmas List” wherein it is added as item 9 with the “C” version selected. Others with multiple overlays are identified by “A”/“B” whilst those with only a single overlay are depicted with no identifier. Accordingly, execution of the playlist within an AVPSAP results in the sequential rendering of the identified items using the overlays selected.

It would be evident, therefore, that such an overlay may be shared, distributed, marketed, emailed, posted, etc. such that another user may play the playlist wherein the media player or AVPSAP accesses each track in sequence and applies the overlay for that track. In instances where the recipient is a subscriber to a media service allowing them to search and stream content the playlist may be exploited in conjunction with the media service such that the recipient listens to the full playlist whether or not they have actually previously purchased and downloaded the individual items of AV content within the playlist. Optionally, the media service may access the overlay and generate an AV item for subsequent download/streaming/purchase by users.

It would be evident to one of skill in the art that whilst the embodiments of the invention described in FIGS. 7 to 10 are depicted and described with respect to elements, functions, etc. within an AVPSAP in execution upon a user's electronic device, what is commonly referred to as the client side. However, it would be evident that these elements, functions, etc. may also be implemented and exploited on the remote servers implementing AVPSAP functions from the service provider, SOCNET, content provider etc. This being commonly referred to as the server side. Accordingly, such features, elements etc. may be solely client side, solely server side or distributed between the server and client sides in different weightings.

For example, referring to FIG. 9 wherein a consensus overlay based upon one of all users, only those within defined time period, family or friends is presented to the user with the ability to set a threshold, i.e. high thresholds are higher popularity elements of the AV content this may alternatively be implemented server side such that the user is able to select within options available to them for an item of AV content a consensus overlay which is generated by the server side processes with predetermined threshold and demographics. As such a consensus overlay to a 20-year-old male for an item of AV content may be different to that for 16-year-old girls or all 50-59 year olds.

For example, an overlay may be generated through crowd sourcing at the server side based upon all users generating overlays or it may be generated client side based upon collating overlays acquired by the user from friends, SOCNETs, purchases, etc. as well as those self-generated. In another instance the AVPSAP may generate a common overlay to be applied to all AV content in addition to the discrete overlay. For example, the AVPSAP may establish that the user never plays any song for more than 2 minutes or that they rarely place an overlay relating to a portion of the AV content to play within the last 25%. Such a common overlay may be applied therefore to all content if selected such that the overlay actually employed is a logical combination, e.g. OR, AND, NOR, etc., of the content specific overlay and the global overlay.

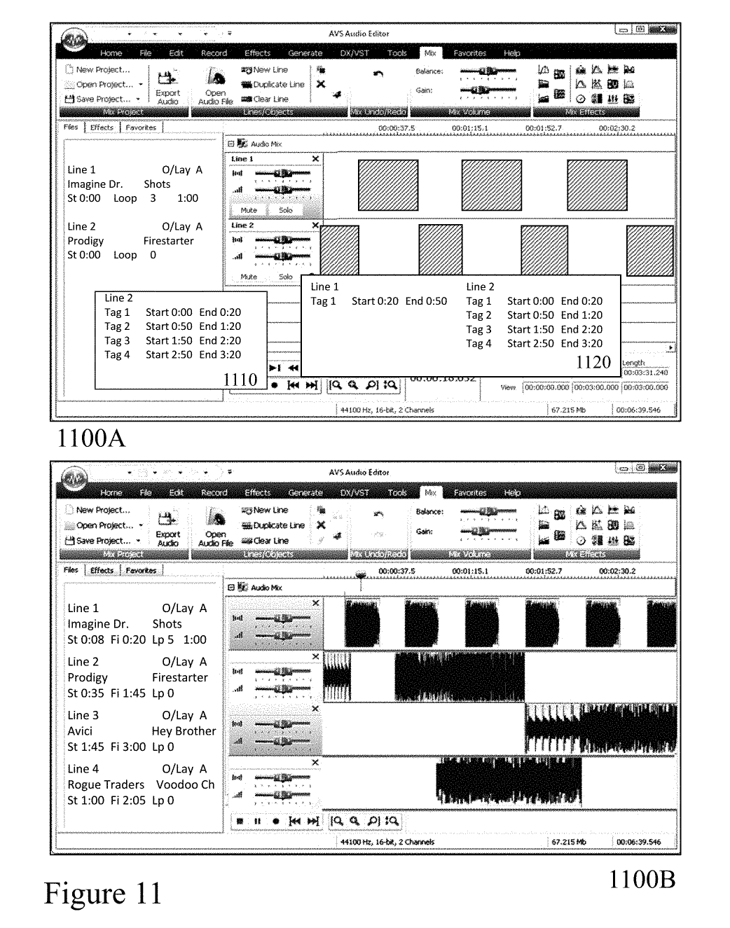

Now referring to FIG. 11 there are depicted first and second SIMSCR 1100A and 1100B of application in execution upon a PED according to an embodiment of the invention providing a user exploiting metadata tag filter based overlays in conjunction with the multi-track AVPSAP (MT-AVPSAP) for generating AV content. In essence such a multi-track AV media player application may be considered as executing a playlist but where the items of AV content rather than being simply sequential in execution may be temporally overlapped to varying degrees as established within the metadata defining the overlay. Referring to first SIMSCR 1100A a user has established two tracks associated with lines 1 and 2 of the MT-AVPSAP. These being:
Line 1 “Shots” by “Imagine Dragons” which is indicated as using Overlay A, having a starting time of 0:00 and being looped 3 times with loops repeating every 1:00 (1 minute); and
Line 2 “Firestarter” by the “Prodigy” which is indicated as using Overlay A, having a starting time of 0:00 and not looping.

Accordingly, the MT-AVPSAP in playing Line 1 starts at time 0:00 and proceeds resulting in tagged portion being played. The MT-AVPSAP subsequently at times 1:00 and 2:00 re-starts the item of AV content associated with Line 1. Further, the MT-AVPSAP begins Line 2 which similarly starts at 0:00 and proceeds according to any tags within that track. Selecting a line, e.g. Line 2, may trigger an editor (see first insert 1110) for the overlay associated with the item of AV content allowing the user to edit the overlay and save as the original overlay or as a new overlay once modified. As the overlay may exploit text based tuples than editing an overlay is a simple task through a text editor interface. However, as the total “playlist” is similarly a concatenation of the individual overlays then the “playlist” may be similarly edited making amendments to the “playlist” straight-forward (see second insert 1120) in comparison to those within a prior art audio mixing system, such as Adobe™ Audition for example. In first SIMSCR 1100A the portions of an item of AV content that have been tagged are displayed as simple blocks along a timeline whereas in second SIMSCR 1100B each tagged section of an item of AV content is displayed as a waveform.

Accordingly, it would be evident that a user through the establishment of an overlay may generate samples without requiring them to exploit an audio editing software application such as Adobe™ Audition as the individual samples may be generated through an AVPSAP audio player and then combined though a relatively low complexity MT-AVPSAP wherein the user can modify the timing/sequence of AV items through a text editor as well as add/remove items.

As noted supra the original media is not altered, edited or amended within embodiments of the invention through the generation and use of one or more overlays in respect to an item of media (AV content). Within other embodiments of the invention an overlay or overlays may be bound to an item of AV content. Within other embodiments of the invention an overlay or overlays is not bound to an item of AV content. Within embodiments of the invention an item of AV content may reside within the memory of a PED and/or FED wherein an AVPSAP stores associations of an overlay or overlays to the item of AV content. Within other embodiments an AVPSAP may store only the overlays which are applied to a temporarily stored copy of the AV content within the memory of a PED and/or FED wherein the AV content is erased upon completion. Optionally, depending upon the AV content file size and the streaming speed available to the PED and/or FED the rendering may begin prior to the full file transfer.

Within embodiments of the invention where multiple overlays are available, either through the user's creation of them or through social media etc., then these may be presented to the user in a filtered manner such as described above in respect of FIGS. 4 to 11 in isolation or with a combination of one or more other factors including a context of the user, a context of the AV content, and a biometric of the user. Optionally, these other factors may be used in isolation or combination. In some embodiments of the invention this filtering may include not displaying overlays and/or removing overlays.

As noted supra a tuple relating to an element of the overlay may include a sign or another indicator as to how the overlay or only that element of the overlay is to be employed. Within the embodiments described supra in respect of FIGS. 4 to 11 respectively the indicator is a positive or negative such that, for example, when the sign is negative this indicates that that portion of the overlay should be ignored (i.e. skipped) with the remainder rendered whereas a positive overlay indicates that that portion should be rendered and those other portions not associated with an element of the overlay should not be rendered. Other indicators may be employed without departing from the scope of the invention.

Referring to FIG. 12 there are depicted first and second SIMSCR 1200A and 1200B for an application in execution upon a PED according to an embodiment of the invention for a user exploiting metadata tag filter based overlays wherein tracks with and without overlays are being played. Referring to first SIMSCR 1200A there is depicted an AVPSAP in execution upon a PED, for example, wherein the user is able to navigate via index pane 1210 their AV library, e.g. playlists, albums, songs displayed, for example, by song title, artist, album title, last played, etc. The currently selected item of AV content is denoted through the visual representation 1230 whilst first player toolbar 1220 allows the user to control the playing (playback) of the AV content selected. In this instance the player toolbar comprises the normal icons for “rewind to start”, “pause” (which converts to play when employed), and “forward to end” together with a timeline of the track and current play position. However, additionally the first player toolbar 1220 includes “rewind 15 seconds” and a “forward 15 seconds” icons allowing the user to essentially “jog” forward/backward 15 seconds. In second SIMSCR 1200B the user is presented with playlist pane 1240 which lists the tracks the user has selected to play at this point or previously by retrieving a stored playlist. However, now second player toolbar 1250 depicts the same toolbar elements as before but now the timeline indicates in addition to the current play position an overlay associated with the track currently being played. As depicted the overlay is a solid bar above the timeline of the track.

Within the embodiments of the invention depicted in FIGS. 12 to 14 a solid bar within an overlay is associated with a local overlay whilst an empty (hollow) bar within an overlay is associated with an intelligent/consensus overlay either derived/defined at the client side or the server side. However, it would be evident that whilst bars denoting elements within an overlay are depicted in FIGS. 12 to 14 other elements/icons etc. may be employed including, but not limited to, those depicted in FIGS. 4 to 6 respectively.

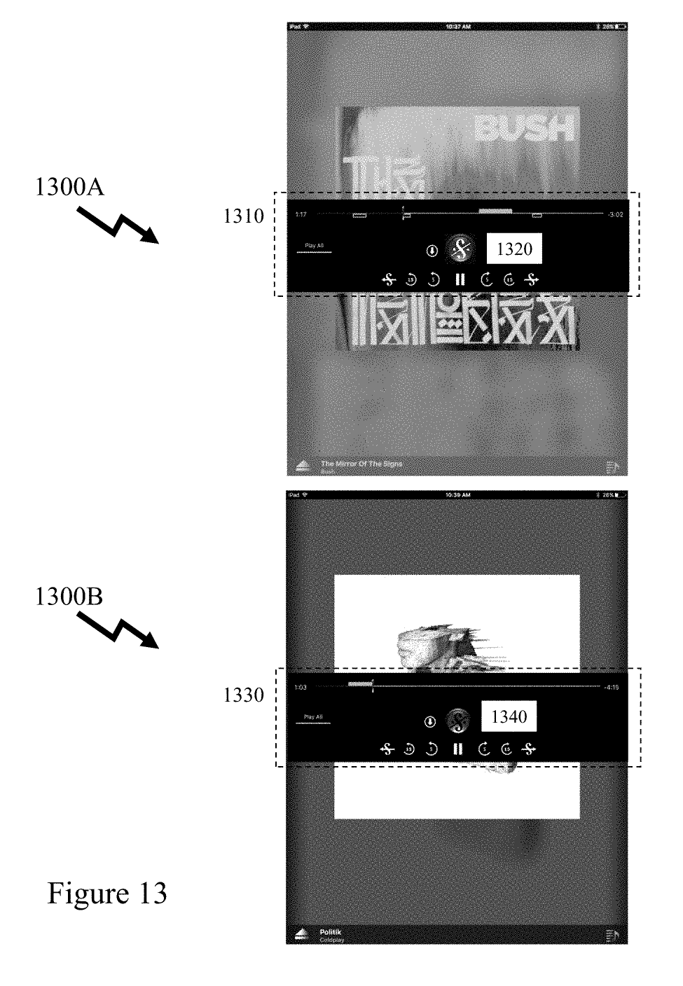

Now referring to FIG. 13 there are depicted first and second SIMSCR 1300A and 1300B for an application in execution upon a PED according to an embodiment of the invention for a user exploiting metadata tag filter based overlays when adding metadata tags to an item of content being played. In first SIMSCR 1300A the user has entered an editor mode within the AVPSAP wherein they are presented with first editor toolbar 1310 with a central button 1320/1340 to start and stop the overlay recording, i.e. defining the start tag and end tag, wherein as indicated in second SIMSCR 1300B the central button 1320/1340 within the second editor toolbar 1330 changes according to whether the overlay is being “recorded” (i.e. set) or not at that time. In playback mode the central button 1320/1340 may adjust depending upon whether a local or consensus overlay is being played. Also depicted adjacent to the central button 1340 is a download button allowing the user to access and download the server side consensus/intelligent overlay for the item of AV content they have accessed. Within other embodiments of the invention their AVPSAP may automatically access and download the consensus overlays for each item of content within a playlist they access or alternatively these may have been previously downloaded and stored wherein the AVPSAP now checks for whether an updated consensus overlay exists as these may be periodically updated, e.g. daily, weekly, etc. or updates may be checked based upon a user set preference.

Within FIG. 13A the central button 1320/1340 is presented as changing according to whether a local or consensus overlay is being played. In other embodiments of the invention the central button 1320/1340 and/or another indicator may adjust in dependence upon a variety of factors including, but not limited to, the AV content, personal preferences of the user, default settings of the AVPSAP, the mode of the AVPSAP, and a current action of the AVPSAP.

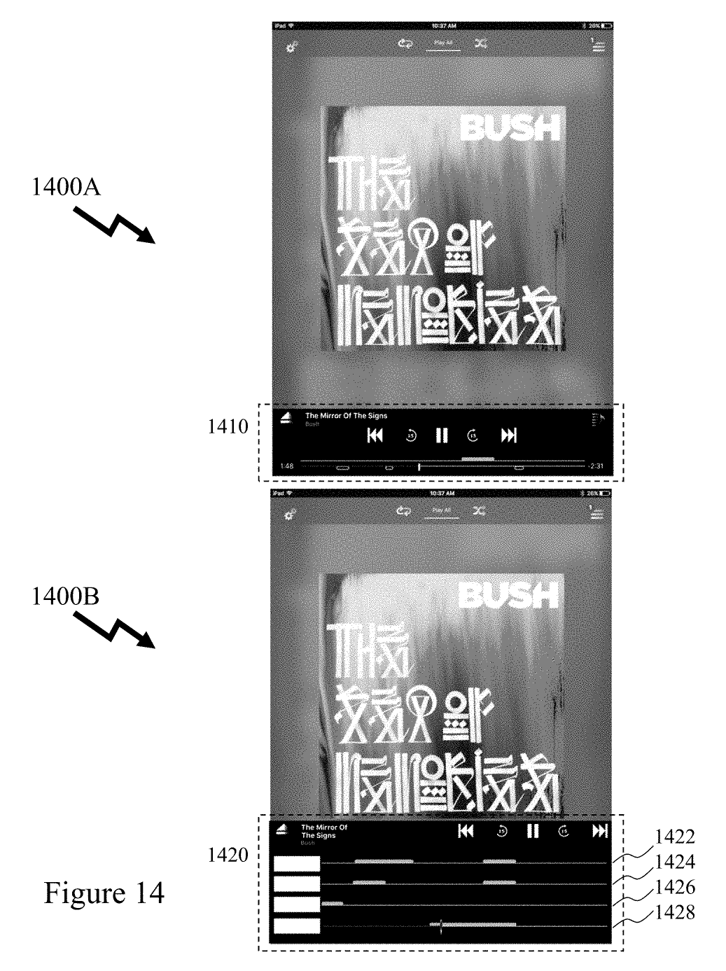

Referring to FIG. 14 there are depicted first and second SIMSCR 1400A and 1400B for an application in execution upon a PED according to an embodiment of the invention for a user exploiting metadata tag filter based overlays wherein the user is shown only a single overlay or multiple overlays. In first SIMSCR 1400A a player toolbar 1410 is depicted for the track “The Mirror of the Signs” by Bush wherein there are depicted the user's local overlay (upper player timeline) and the consensus overlay (lower player timeline). The consensus overlay is depicted with a marker indicating the position of the playback within the time and with different colors either side of the marker. In second SIMSCR 1400B the same track is displayed but now a second player toolbar 1420 has four overlays displayed indicated as “Upbeat”, “Vocal”, “Ringtone”, and “Bass Drum.” Of these the marker in respect of the overlay being played is indicated within the overlay “Bass Drum.” It would be evident to one skilled in the art that more overlays may be displayed to the user within the player toolbar 1420 which where more than the number that can be displayed at once is supported through a scrolling display. Within embodiments of the invention the title of an overlay is stored within the data file associated with the overlay such that when the overlay is accessed by the user, another user, etc. the title is presented and may be used to search for overlays within other embodiments of the invention. Optionally, additional information such as date/time of overlay creation, identity information of overlay creator, etc. may also be stored within the overlay or transmitted separately to the overlay.

Within other embodiments of the invention a user may associate one or more descriptors, e.g. hashtags, in association with an overlay they have generated. These descriptors may be employed in allowing a user to subsequently search their own overlays or those of others within their social networks, etc. Within the second SIMSCR 1400B these descriptors provide the displayed text of “Upbeat”, “Vocal”, “Ringtone”, and “Bass Drum.” It would be evident that server side analysis and processing may associate one or more descriptors with a consensus overlay based upon the dominant descriptor(s) employed by users when creating them.

Within the embodiments described supra in respect of FIGS. 4 to 11 respectively the overlays described may be considered simple overlays in that they are established by the user directly when rendering an item of AV content or through a text editor or generated through a simple mathematical process, e.g. summation. More complex overlays, which the inventors refer to as “intelligent overlays” which may be created by merging a plurality of “simple” using an algorithm. As evident from the embodiments described supra in respect of FIGS. 4 to 11 respectively “simple” user generated overlays may be stored locally (client side) upon a user's PED and/or FED whereas “intelligent overlays” by exploiting data from social networks, AVPSAP databases, etc. typically are available/accessible when there is network connectivity as they are stored remotely (server side). As evident from the embodiments described supra in respect of FIGS. 4 to 11 respectively simple and intelligent overlays allow a user to access/render (play) multiple different versions from a single source object (item(s) of AV content). This may, for example, be employed in creating abridged versions of audio books, abridged e-books or other documents exploiting a portable document format (e.g. Adobe™ PDF), for censoring an item of AV content, shortening video such as films or television shows making them suitable for broadcast.

Optionally, a user may vote up or down an intelligent overlay thereby giving it a dynamic nature. A user's taste may change over time and they may prefer to change how a consensus or intelligent overlay is calculated as well as the portion(s) of the AV content that they would like to tag. For example, an AVPSAP may allow a user to change a default “all” user consensus algorithm to one demographically defined such that it is defined by those fitting the demographic of being located in North America, 18-25 years old, and female. However, subsequently the user could amend to remove the sex based demographic filter. Accordingly, the demographic filters may be adjusted but additionally the user's vote in respect of the resultant consensus filter may be blended into the algorithm such that where for example a consensus overlay of all users is heavily weighted to a particular demographic, e.g. 14-18-year-old females, then the user's “down” vote may adjust the demographic for the consensus overlay to that item of AV content and/or similar items of AV content or those having a similar demographic skew. This will result in the algorithm generating different intelligent overlays at another point in the future.

Simple overlays are typically created manually by a user using a graphical user interface as part of an AV rendering/management tool, via a graphical user interface, or they can be captured and imported as text. In contrast, intelligent overlays are typically created automatically by an algorithm of a plurality off algorithms as discussed below. Accordingly, simple overlays may be generated by a user and shared with other users via a network and/or social network via one or more central control servers that store these simple overlays along with the identity of the creator of the simple overlay and generate the intelligent overlays. Simple overlays may, for example, be generated by:
a user may render an audio recording or a video and manually record the time segments that they would like to capture and enter them into a client application during the rendering or subsequently; and
a user may use an automated approach such as a PED and/or FED application or other computerized hardware or software to capture the data and have it automatically saved locally and/or shared.

As noted supra one or more algorithms may be employed to generate an intelligent overlay from a single simple overlay or from a plurality of simple overlays. For example, a user defining portions of an audio track may establish times that are not aligned to natural pauses/gaps/beats within the audio track. Accordingly, a user may exploit an algorithm to generate an intelligent overlay from their simple overlay so that the timings are “auto-corrected” to fit a pause, gap, beat etc. Optionally, this may be based upon processing a short period of the audio track around the timing indicated by the user to determine any corrected timing or an algorithm may merge multiple simple overlays together that have the timing indicated within some predetermined timing error, e.g. 5 seconds, so that the average of a large number of users is employed. Optionally, the user may be prompted to exploit an algorithm after they have generated their simple overlay or the use of a number of predetermined algorithms may be established through the user's preferences within the AVPSAP.

For example, an algorithm may take data from overlays which are then plotted/analysed as two-dimensional (2D) data with an X-axis of time bins around the user specified location, whilst the Y-axis is the number of times that time bin occurs within the data set employed, e.g. all overlays for that track, only family, only friends, only those within the past week, etc. This 2D data is then fitted to determine the timing relating to the center of the distribution. Equally, an algorithm may merge identified portions if they are close enough in time or if they have any overlap.

In other embodiments of the invention an algorithm may have variable parameters that can be altered dynamically during processing by the AVPSAP or through user preferences, for example, such that higher quality intelligent overlays are produced. For example, the threshold and duration of an overlay may be altered such that element(s) may be deleted as that portion or portions may have a high quality factor, i.e. aligns to the consensus timing, but is not sufficient duration or remove a portion or portions exceeding a minimum duration but lacking the quality threshold.

Within the embodiments described supra in respect of FIGS. 4 to 11 respectively simple and/or intelligent overlays may be shared, distributed, sold, etc. without sharing the AV content which may be copyrighted material. Overlays may be distributed either automatically without any user action or alternatively, they can be distributed on-demand requiring a trigger by the user.

Typically, a low percentage, e.g. 1%, of users are creators/generators of content, e.g. overlays, whereas a high percentage of users, e.g. the remaining 99%, typically simply consume content. Accordingly, the distribution of intelligent overlays can be very important within embodiments of the invention. In order to distribute intelligent overlays a user may share metadata for their own media library. This metadata is then matched up against the metadata stored in the central control server to indicate which intelligent overlays to transmit from the server to the user. Any overlays downloaded in association with an item of AV content may be employed, or they may be over-written when the user generates their own. For example, an intelligent overlay may provide a 10 second ringtone for a PED based upon the item of AV content but the user can subsequently, having heard and/or rendered the original AV content item, establish a new overlay for their ringtone which over-writes the one stored within their PED and is employed automatically when a ringtone is to be generated.

Accordingly, overlays as described within the embodiments supra in respect of FIGS. 4 to 11 respectively and other embodiments of the invention may be used in one or more modes including but not limited to:
Employing simple overlays that render only the sections of an item of AV content personally selected by that user;
Employing intelligent overlays that render sections of an item of AV content that correspond to time markers formed via consensus from other users with or without user data factoring into the intelligent overlay generation;
Employing expert overlays that render sections of an item of AV content based upon time markers created by a single expert, e.g. for an audio content item the expert overlay may be generated by another well-known artist/DJ etc. or an individual the user follows within a media specific social network, e.g. SoundCloud™ for music, YouTube™ for video, etc.; and
Ignored wherein the media player or AVPSAP renders the entire media item irrespective of time markers set with respect to that media item.

Simple, expert, and/or intelligent overlays may be employed once (i.e. they expire after single use), a predetermined number of renderings, a predetermined time limit expiring, or indefinitely. Overlays may be combined, looped, re-ordered, or used in any other manner.

Within the embodiments described supra in respect of FIGS. 4 to 11 respectively as well as other embodiments then essentially any media player can be modified to exploit overlays as there is no change to the original media content and/or its format and the overlay defines what portion(s) are to be rendered to the user and/or played sequentially, discretely, or in parallel to other items and/or portions of content including the same item of content. Accordingly, no new data format and/or media converter is required to support the use of overlays. For audio, embodiments of the invention can be employed, for example, in conjunction with MP3 regardless of bit-rate, Advanced Audio Coding (AAC), WAV, etc. For visual media, the use of MP4, MPEG, and QuickTime are supported together with WMV, AVI, Ogg Video, etc.

Within the embodiments described supra in respect of FIGS. 4 to 11 respectively the context has been primarily described with respect to digital environments and/or digital media. However, it would be evident to one skilled in the art that embodiments of the invention may also be employed in conjunction within analog environments.

Within the embodiments described supra in respect of FIGS. 4 to 11 respectively overlays, such as intelligent overlays, may be voted up or down by users within a social network or networks as well as based upon number of uses, downloads etc. thereby giving them a dynamic nature in addition to the fact that an intelligent overlay may vary with time through one or more algorithms processing different overlays from users and/or an increasing quantity of overlays. A user's taste may change over time and they may prefer to change a portion of media that they would like to tag wherein they adjust initially their local simple overlay but subsequently this is processed with an algorithm or algorithms via network access to generating a different intelligent overlay. Optionally, a user may elect to freeze an overlay or an intelligent overlay may be frozen once a predetermined point has been reached, e.g. a predetermined number of overlays, such that popular items of AV content do not result in excessive processing requirements on local and/or remote processing units in generating one or more intelligent overlays for that item of AV content.

Optionally, overlays may be voted upon within a voting system. Accordingly, a user when downloading an item of AV content may elect to download one or more simple, expert, or intelligent overlays with it wherein these may be weighted differently based on user votes. Within an embodiment of the invention a user may gain reputation points based upon their overlay being downloaded and receiving positive voting thereby increasing the value of their overlay submissions. Subsequently, some users may reach a sufficient reputation level that designates them as an expert in addition to or separate from other experts such as recognized overlay generators such as DJs for music, film reviewers/directors/producers for video, etc. An expert's simple overlays can be converted directly to intelligent overlays bypassing the algorithm. A user may subscribe to a specific expert's intelligent overlays.

Within embodiments of the invention an overlay has been described as being generated through a set of tuples defining portions of the content to be rendered and/or skipped wherein through provisioning of start/end or start/duration metadata a low file size is achieved as defining a single section to render or skip requires a single tuple and potentially just two text elements. However, within other embodiments of the invention the user's designations of the portions to be rendered/skipped may be converted prior to storage into another format defining the media player and/AVPSAP function. For example, a tag may be assigned to every second of an audio track and defined as “+1” for example to render or “−1” or “0” to skip. Whilst such embodiments require additional data be stored and require additional processing complexity for the media player and/or AVPSAP to find transitions allowing seamless rendering they may be employed in some instances or with certain media and/or specific media players and/or AVPSAPs.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and/or various other mediums capable of storing, containing or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g. software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method of rendering an item of audiovisual content to a user comprising:
retrieving the item of audiovisual content;
retrieving an overlay relating to the item of audiovisual content comprising at least one tuple of a plurality of tuples, each tuple comprising data relating to timing information; and
rendering the item of audiovisual content in dependence upon the at least one tuple of the plurality of tuples.

2. The method according to claim 1, wherein
the tuple of the plurality of tuples defines a portion to be rendered or a portion to be skipped.

3. The method according to claim 1, wherein
at least one of:
the overlay was generated by the user or another user previously rendering the item of audiovisual content and providing indications to a media player that are subsequently stored as the tuple of the plurality of tuples;
the overlay was generated by the user or another user using an editor to enter the tuple of the plurality of tuples;
the overlay was generated by an algorithm of a plurality of algorithms being applied to an initial overlay generated by at least one of the user and another user.

4. The method according to claim 1, wherein
the retrievals and rendering are performed upon one of a portable electronic device associated with the user, a fixed electronic device associated with the user, and a remote server streaming audiovisual content to the user.

5. A method of rendering an item of audiovisual content to a user comprising:
generating an overlay relating to the item of audiovisual content comprising at least one tuple of a plurality of tuples, each tuple comprising data relating to timing information; and
storing the overlay for subsequent retrieval in order to render the item of audiovisual content in dependence upon the at least one tuple of the plurality of tuples.

6. The method according to claim 5, wherein
the tuple of the plurality of tuples defines a portion to be rendered or a portion to be skipped.

7. The method according to claim 5, wherein
at least one of:
the overlay was generated by the user or another user previously rendering the item of audiovisual content and providing indications to a media player that are subsequently stored as the tuple of the plurality of tuples;
the overlay was generated by the user or another user using an editor to enter the tuple of the plurality of tuples;
the overlay was generated by an algorithm of a plurality of algorithms being applied to an initial overlay generated by at least one of the user and another user.

8. The method according to claim 5, wherein
the overlay generation is performed upon one of a portable electronic device associated with the user or a fixed electronic device associated with the user; and
the rendering is performed upon one of the portable electronic device associated with the user, the fixed electronic device associated with the user, and a remote server streaming audiovisual content to the user.

9. A data file comprising:
an identifier of an item of audiovisual content; and
at least one tuple of a plurality of tuples, each tuple comprising data relating to timing information for rendering the item of audiovisual content.

10. The data file according to claim 9, wherein
the identifier and the at least one tuple of the plurality of tuples form an overlay to the item of audiovisual content, wherein
the overlay was generated by the user or another user previously rendering the item of audiovisual content and providing indications to a media player that are subsequently stored as the tuple of the plurality of tuples;
the overlay was generated by the user or another user using an editor to enter the tuple of the plurality of tuples;
the overlay was generated by an algorithm of a plurality of algorithms being applied to an initial overlay generated by at least one of the user and another user.

11. The data file according to claim 9, wherein
the data file was generated upon one of a portable electronic device associated with a user or a fixed electronic device associated with the user; and
the rendering is performed upon one of the portable electronic device associated with the user, the fixed electronic device associated with the user, and a remote server streaming audiovisual content to the user.

12. The data file according to claim 9, wherein
the data file is associated with the item of audiovisual content within at least one of a software application and a media player supporting the rendering of the item of audiovisual content.
